(19) United States
(12) Patent Application Publication
(10) Pub. No.: US 2022/0258739 A1
(43) Pub. Date: Aug. 18, 2022

(54) Method and System for Generating a Confidence Value in a Position Overlap Check Using Vehicle Threshold Models

(71) Applicant: QUALCOMM incorporated, San Diego, CA (US)

(72) Inventors: Jean-Philippe Monteuuis, Levallois-Perret (FR); Jonathan Petit, Wenham, MA (US); Mohammad Raashid Ansari, Lowell, MA (US); Cong Chen, Shrewsbury, MA (US)

(21) Appl. No.: 17/177,574

(22) Filed: Feb. 17, 2021

(51) Int. Cl. B60W 40/09; B60W 50/10; H04W 4/40; H04W 4/029; G06K 9/00

(52) U.S. Cl. CPC B60W 40/09; B60W 50/10; G06K 9/00791; H04W 4/029; H04W 4/40

(57) ABSTRACT

Embodiments are disclosed that include systems and methods performed by vehicle-to-everything (V2X) system participant to identify position overlap misbehavior conditions efficiently by using vehicle threshold model data rather than specific second vehicle dimension data. The vehicle threshold model data may include a confidence value for the dimension data contained therein such that a confidence level for the identification of a position overlap misbehavior condition may be calculated. The calculated confidence values may allow the V2X system participant to determine whether to generate a misbehavior detection report (MBR) and transmit the MBR to a misbehavior managing authority.

### BACKGROUND

Intelligent Transportation Systems (ITS) aim to provide services relating to different modes of transport and traffic management, enable users to be better informed and make safer, more coordinated and ‘smarter’ use of transport networks. These transport networks include advanced telematics and hybrid communications including Internet Protocol (IP) based communications as well as Ad-Hoc direct communication between vehicles and between vehicles and infrastructure. An evolving Cooperative-ITS (C-ITS) seeks to improve road safety and pave the way towards the realization of full autonomous driving based on the exchange of information via direct wireless short range communications dedicated to C-ITS and Road Transport and Traffic Telematics (RTTT).

Multiple regions of the world are developing standards for vehicle-based communication systems and functionality. For example, standards are being developed in the Institute of Electrical and Electronics Engineers (IEEE) and Society of Automotive Engineers (SAE) for use in North America. or in European Telecommunications Standards Institute (ETSI) and European Committee for Standardization (CEN) for use in Europe. Part of that system is the ability for a vehicle to broadcast Basic Safety Messages (BSM) in North America or Cooperative Awareness Messages (CAM) in Europe, which other vehicles can receive and process to improve traffic safety. The processing of such BSM messages in the transmitting and receiving vehicles occurs in onboard equipment that provide the vehicle-to-everything (V2X) functionality (referred to herein as “V2X onboard equipment”).

The cellular vehicle-to-everything (C-V2X) protocol is one such protocol being developed as a foundation for vehicle-based wireless communications that may be used to support intelligent highways, autonomous and semi-autonomous vehicles, and improve the overall efficiency and safety of the highway transportation systems.

The C-V2X protocol defines two transmission modes that, together, provide a 360° non-line-of-sight awareness and a higher level of predictability for enhanced road safety and autonomous driving. A first transmission mode includes direct C-V2X, which includes vehicle-to-vehicle (V2V), vehicle-to-infrastructure (V21), and vehicle-to-pedestrian (V2P), and that provides enhanced communication range and reliability in the dedicated Intelligent Transportation System (ITS) 5.9 gigahertz (GHz) spectrum that is independent of a cellular network. A second transmission mode includes vehicle-to-network communications (V2N) in mobile broadband systems and technologies, such as third generation wireless mobile communication technologies (3G) (e.g., global system for mobile communications (GSM) evolution (EDGE) systems, code division multiple access (CDMA) 2000 systems, etc.), fourth generation wireless mobile communication technologies (4G) (e.g., long term evolution (LTE) systems, LTE-Advanced systems, mobile Worldwide Interoperability for Microwave Access (mobile WiMAX) systems, etc.), fifth generation wireless mobile communication technologies (5G NR systems, etc.), etc. Other V2X wireless technologies are also under consideration in different regions of the world. The techniques described in this patent are applicable to any V2X wireless technology.

### SUMMARY

Various aspects include methods performed by a V2X system participant's processor to detect overlap misbehavior conditions efficiently by utilizing vehicle dimensions contained in pre-set threshold vehicle models. By utilizing vehicle dimensions contained in pre-set threshold vehicle models the V2X system participant processor does not need to obtain the plurality of possible vehicle dimensions. Rather the overlap condition may be determined using a limited set of possible vehicle dimensions. By limiting the set of possible dimensions, the overlap condition may be more efficiently determined.

Various aspects may include determining a first vehicle position and a first vehicle orientation of a first vehicle; determining a first vehicle dimensional boundary in which the first vehicle dimensional boundary is based on a first vehicle length, a first vehicle width, the first vehicle position, and the first vehicle orientation, receiving a V2X message from a second vehicle in which the V2X message includes a second vehicle position and a second vehicle orientation, selecting a vehicle threshold model for the second vehicle from a set of vehicle threshold models in which the selected vehicle threshold model includes a selected vehicle threshold model length and a selected vehicle threshold model width, and a selected vehicle threshold model confidence value; determine a second vehicle dimensional boundary in which the second vehicle dimensional boundary is based on the second vehicle position, the second vehicle orientation received in the V2X message, the selected vehicle threshold model length and the selected vehicle threshold model width, determining whether any portion of the first vehicle dimensional boundary overlaps any portion of the second vehicle dimensional boundary, identifying a position overlap misbehavior condition in response to determining that any portion of the first vehicle dimensional boundary overlaps any portion of the second vehicle dimensional boundary, generating a misbehavior report that identifies the position overlap misbehavior condition, and transmitting the misbehavior report to a misbehavior managing authority.

Some aspects may further include selecting the vehicle threshold model from a set of vehicle threshold models for a current geographic area in response to determining that the first vehicle has left a first geographic area and entered the current geographic area, in which the set of vehicle threshold models for the current geographic area is different than the set of vehicle threshold models for the first geographic area.

Some aspects may further include the first vehicle calculating a confidence level for the identification that a misbehavior condition has occurred in response to identifying the overlap misbehavior condition, in which the confidence level for the identification that a misbehavior condition has occurred is based on the selected vehicle threshold model confidence value. By calculating the confidence level of the determined overlap misbehavior condition, the V2X system participant processor may determine whether the detection of the overlap misbehavior condition should be confirmed by a separate entity such as a misbehavior managing authority. In some aspects, a length and a width may be assigned to the second vehicle in the vehicle threshold model based on a distribution of vehicle length and vehicle width in in a current geographic area. In some aspects, the first vehicle may assign the first vehicle length and the first vehicle width from values contained in the selected vehicle threshold model.

In some aspects, the set of vehicle threshold models may include a minimum vehicle threshold model including minimum dimensions and a minimum vehicle confidence value for a minimum vehicle size in the current geographic area, in which the minimum dimensions may include a minimum vehicle length and a minimum vehicle width; and a maximum vehicle threshold model comprising maximum dimensions and a maximum vehicle confidence value for a maximum vehicle size in the current geographic area, in which the maximum dimensions may include a maximum vehicle length that is greater than an actual longest vehicle length and a maximum vehicle width that is greater than an actual widest vehicle width.

In some aspects, the selected vehicle threshold model may include a selected threshold vehicle length, a selected threshold vehicle width and a selected threshold vehicle confidence value of a threshold vehicle in the current geographic area, in which the selected threshold vehicle confidence value of the threshold vehicle may be a percentage of all vehicles in the current geographic area minus a percentage of vehicles in the current geographic area having an actual length greater than the length of the vehicle threshold model and having an actual width greater than the width of the vehicle threshold model, and in which the calculated confidence level equals the percentage of vehicles smaller than the minimum dimensions minus the selected vehicle threshold model confidence value of the threshold vehicle in the current geographic area.

In some aspects, the set of vehicle threshold models may include a minimum vehicle threshold model that may include minimum dimensions and a minimum vehicle confidence value for a minimum vehicle size in the current geographic area, in which the minimum dimensions may include a minimum vehicle length that is less than an actual shortest vehicle length and a minimum vehicle width that is less than an actual narrowest vehicle width; and a maximum vehicle threshold model that may include a maximum dimensions and a maximum vehicle confidence value for a maximum vehicle size in the current geographic area, in which the maximum dimensions may include a maximum vehicle length and a maximum vehicle width.

In some aspects, the selected vehicle threshold model may include a selected threshold vehicle length, a selected threshold vehicle width and a selected threshold vehicle confidence value of a threshold vehicle in the current geographic area, in which the selected threshold vehicle confidence value of the threshold vehicle may be a percentage of all vehicles in the current geographic area minus a percentage of vehicles in the current geographic area having an actual length greater than the length of the vehicle threshold model and having an actual width greater than the width of the vehicle threshold model, and in which the calculated confidence level equals the percentage of vehicles larger than the maximum dimensions minus the selected vehicle threshold model confidence value of the threshold vehicle in the current geographic area.

Further aspects may include a V2X system having a processor configured to perform one or more operations of any of the methods summarized above. Further aspects include V2X system having means for performing functions of any of the methods summarized above. Further aspects may include a non-transitory processor-readable storage medium having stored thereon processor-executable instructions configured to cause a V2X system processor to perform operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIGS. 1A and 1B are component block diagrams illustrating a vehicle suitable for implementing various embodiments.

FIG. 1C is a component block diagram illustrating components of a vehicle suitable for implementing various embodiments.

FIG. 1D is a schematic block diagram illustrating a subset of a V2X communication system suitable for implementing various embodiments.

FIG. 2A is a component block diagram illustrating components of an example V2X system participant management system according to various embodiments.

FIG. 2B is a component block diagram illustrating components of another example V2X system participant management system according to various embodiments

FIG. 3 is a block diagram illustrating components of a system on chip for use in a V2X system participant in accordance with various embodiments.

FIG. 4A illustrates a number of example scenarios that may occur when an accurate threshold vehicle model is chosen and an inaccurate threshold vehicle model is chosen.

FIG. 4B illustrates additional examples of position overlap misbehavior condition detection anomalies that may occur when inaccurate dimensions are assigned to other V2X system participants, such as a pedestrian.

FIG. 5 illustrates more accurate vehicle threshold models for use with various embodiment methods disclosed herein.

FIG. 6A is a process flow diagram illustrating operations of a method for efficiently performing a position overlap misbehavior detection consistent with various embodiments disclosed herein.

FIG. 6B is a process flow diagram illustrating operations of another method for efficiently performing a position overlap misbehavior detection consistent with various embodiments disclosed herein.

FIG. 7 is a component block diagram illustrating an example mobile computing device suitable for use with Various embodiments.

FIG. 8 is a component block diagram illustrating an example mobile computing device suitable for use with Various embodiments.

FIG. 9 is a component block diagram illustrating an example server suitable for use with Various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The term “mobile device” is used herein to refer to any one or all of wireless router devices, wireless appliances, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, medical devices and equipment, biometric sensors/devices, wearable devices including smart watches, smart clothing, smart glasses, smart wrist bands, smart jewelry (e.g., smart rings, smart bracelets, etc.), entertainment devices (e.g., wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, mobile devices affixed to or incorporated into various mobile platforms, global positioning system devices, and similar electronic devices that include a memory, wireless communication components and a programmable processor.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single mobile device. The proximity of the SOCs facilitates high speed communications and the sharing of memory and resources.

As used in this application, the terms “component.” “system.” “unit.” “module,” and the like include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

In overview, various embodiments include methods and systems of efficiently detecting that an overlap misbehavior condition has occurred and determining a confidence level in the detection of the overlap misbehavior condition. In V2X communications, a misbehavior condition may be detected by analyzing various sensor data to insure that the vehicle is operating in a consistent manner. One type of significant misbehavior condition is a location overlap condition or simply an overlap condition. An overlap misbehavior condition occurs in instances in which the dimensional boundary of one entity (e.g., vehicle or pedestrian) overlaps the dimensional boundary of another entity. Such a condition would indicate that the entities have collided or contact one another. If the vehicles are continuing, it is most likely that the vehicles do not in fact overlap, and thus indicating that one or the other of the vehicles' location and/or boundary dimensions are not trustworthy, and thus exhibiting an overlap misbehavior condition.

In most cases, a wide variety of entity dimensions may exist. For example, different types of entities (e.g., vehicles, pedestrians, trucks, motorcycles, and bicycle all have significantly different dimensions, particularly different lengths and different widths. Further, different models of vehicles have different dimensions (length and width). Even vehicles of the same model may be customized to have different dimensions (e.g., length and width). Thus, it is helpful to have an accurate knowledge of each of these varying dimensions of two or more entities (e.g., vehicles) to determine accurately whether an overlap misbehavior condition is occurring. Given the variability of entity dimensions, it may be cost or resource prohibitive to store the dimensions of every possible entity that may be encountered in an ITS. While entity dimensions may be estimated, such estimations may result in an inaccurate misbehavior condition detection. Thus, in order to improve the accuracy of the V2X system, determining a confidence level in the detection of a misbehavior condition may be beneficial. For example, in instances in which the confidence level of a misbehavior condition detection is below a threshold level, the detection of the occurrence of a misbehavior condition may be transmitted to a misbehavior managing authority for confirmation of the misbehavior condition.

Overlap conditions may occur when portions of another entity's dimensional boundary overlaps another entity's dimensional boundary in any of length, width, and height. For ease of reference, various embodiments are described within the context of surface travel (i.e., roadway) in which the two dimensions of length and width are critical, and thus vehicle dimensions may be referred to as length and width. However, in some applications, overlaps in three dimensions will be important, such as with flying drones, aircraft, and watercraft). Various embodiments disclosed herein are not intended to be limited to surface travel. Various embodiments may include three dimensional boundaries based on entity length, width and height.

In some instances, an actual overlap condition may occur (e.g., collision, accident, etc.). However, vehicles generally try to avoid collisions and thus avoid overlap conditions. Nevertheless V2X systems may detect an overlap condition when location and/or orientation sensors malfunction and provide inaccurate location and/or orientation data for an entity (e.g., vehicle or pedestrian). Also, V2X systems may detect an overlap condition when malicious actors hack V2X systems and inject corrupted or inaccurate entity location data into the system. Thus, the detection of an overlap condition may be inaccurate, representing a misbehavior condition, in instances in which the sensor data supporting the conclusion that an overlap condition has occurred is inaccurate. Thus, detecting an overlap condition that is inconsistent with other information, such as the vehicles are continuing to travel at normal speeds, may be treated as a detection that a misbehavior condition has occurred.

In response to the detection that a misbehavior condition has occurred, a misbehavior condition report (MBR) may be generated and transmitted to a misbehavior managing authority for confirmation that the misbehavior condition actually occurred. The MBR may contain sensor data that supports the conclusion that a misbehavior condition has occurred. In some instances, the misbehavior managing authority may analyze the received MBR and supporting sensor data determine that various sensors have malfunctioned and need replacement or repair. In other instances, the misbehavior managing authority may analyze the received MBR and supporting sensor data determine that a malicious actor may have infiltrated the V2X system and has corrupted the sensor data.

As more and more V2X systems come online, the number of potential MBR being generated and transmitted may become overwhelming. Thus, it may be desirable to calculate a confidence level that the detected misbehavior condition is accurate before the MBR is generated and transmitted to a misbehavior managing authority.

V2X systems and technologies hold great promise for improving traffic flows and vehicle safety by enabling vehicles to share information regarding their location, speed, direction of travel, braking, and other factors that may be useful to other vehicles for anti-collision and other safety functions. Vehicles equipped with V2X/V2V onboard equipment will frequently (e.g. up to 20 times per second) transmit their vehicle information in packets referred to as Basic Safety Messages (BSM) or Cooperative Awareness Message (CAM). With all V2X equipped vehicles transmitting such BSM/CAM messages, all receiving vehicles have the information required to control their own speed and direction to avoid collisions and efficiently and safely position vehicles with respect to each other. It is envisioned that V2X equipped vehicles may be able to improve traffic flow by safely reducing separation distances, platooning several vehicles together, and avoiding vehicles experiencing breakdowns.

For ease of reference, some of the embodiments are described in this application as performed by a V2X system participant operating within V2X terminologies. However, it should be understood that various embodiments encompass any or all of the V2X/V2V or vehicle-based communication standards, messages or technologies. As such, nothing in the application should be construed to limit the claims to V2X/V2V systems unless expressly recited as such in the claims. In addition, the embodiments described herein discuss onboard equipment to perform V2X/V2V communication. In V2X/V2V systems, system participant equipment may include, but is not limited to, vehicle on-board equipment, mobile devices, and roadside units (RSU). RSUs may include stationary devices such as traffic signals, roadside beacons, traffic cameras, etc. Each of system participant equipment may broadcast information to other system participant equipment. For example, a vehicle may contain on-board/in-dash equipment and sensors that report on vehicle conditions (e.g., location, orientation, speed, dimensions, etc.). A mobile device carried by a pedestrian or vehicle rider (e.g., motorcycle, car, bicycle rider) may contain sensors that report on pedestrian conditions (e.g., location, orientation, speed, dimensions, etc.). Each of the vehicle, pedestrian and RSU may be a V2X system participant. The processor contained in the in-dash/onboard unit or mobile device may be considered the V2X system participant processor. The V2X communication among V2X system participant equipment may allow applications executing on each V2X system participant equipment to provide vehicles and pedestrians with safety applications (e.g., applications that may determine imminent hazards such as a vehicle hard-braking or speeding out of a blind cross-street) or mobility (planning for traffic signal changes), or provide other useful functions within the vehicular transportation system as a whole. For case of reference, Various embodiments described below discuss vehicles (e.g., car). Such discussion is not intended to limit any of the embodiments for use with vehicles. Rather the embodiments described herein may be used by any V2X system participant to detect overlap conditions with any other V2X system participant.

Misbehavior reporting is a key part of the security system for V2X communications. In misbehavior reporting, field devices—vehicles or roadside units (RSUs)—observe V2X messages, determine that the contents of those V2X messages are not consistent with the totality of V2X system participant sensor and observation data, and generate a misbehavior report (MBR) that can be sent to a Misbehavior Managing Authority. In instances in which the V2X message is not consistent with the totality of vehicle sensor and observation data a misbehavior condition may be detected and a MBR may be generated. The Misbehavior Managing Authority may aggregate MBRs from different reporting V2X system participants from across the Misbehavior Managing Authority's region of responsibility and determines possible responses to the MBRs. There may be a wide range of potential response, including among others: determining that the MBRs are not actually reporting valid misbehavior conditions; determining that the reported MBRs are actual misbehavior conditions but are causing so little disruption that it would cost more to fix it than to let it continue; determining that a reporting V2X participant has bad software and needs to be updated; determining that the signing keys associated with a V2X participant have been extracted from the V2X system participant and are being used to mount a nationwide attack of bad messages, and so the device keys need to be revoked so that no-one trusts them further.

In most V2X systems, the Misbehavior Managing Authority may require sufficient evidence to verify/confirm the accuracy of the generated MBR, i.e., that if the evidence presented is correct, the misbehavior condition that was reported in the MBR was indeed misbehavior. The sufficient evidence may vary depending on the particular type of misbehavior condition. For example, a MBR claiming to be from a V2X participant travelling at 1000 miles per hour may be deemed to be a misbehavior condition in its own right, without any need of any evidence as no known vehicle operating within a V2X system is capable of achieving such a speed. In other cases, the reporting V2X participant (i.e., first vehicle) may be requested to send additional data, such as sensor data—for example, in the instance in which where the reported V2X message is from a vehicle claiming to be neighboring to the V2X participant (i.e., second vehicle) that is reporting the MBR, but the reporting V2X participant's sensor data does not detect any such neighboring second vehicle. Thus, the reporting V2X participant (e.g., first vehicle) that receives the original V2X message may determine that a misbehavior condition has occurred with the alleged neighboring second vehicle. However, in many instances, although including sensor data raises concerns about the trustworthiness of the reporter, including such sensor data may permit the Misbehavior Managing Authority to obtain a much more complete picture of potential misbehavior and therefore including such supporting sensor data with the MBR should be the standard practice.

A significant misbehavior condition that may be detected by a V2X system is position overlap. Since position overlap in the real word indicates a collision or impending collision between two vehicles, vehicles operate to avoid position overlap. In order to determine whether position overlap has occurred, knowledge regarding a first vehicle's position, orientation, and dimensions as well as a second vehicle's position, orientation, and dimensions are required. Simplification of any of these variables may allow for a more efficient detection of the position overlap condition. Thus, various embodiments disclosed herein include methods that simplify the detection of the position overlap condition by limiting the number of possible vehicle dimensions that need to be evaluated. While such limitations may allow for a more efficient detection of the position overlap position, such detection may not be accurate. Thus, various embodiments include methods for determining a confidence level of the detection of a position overlap condition.

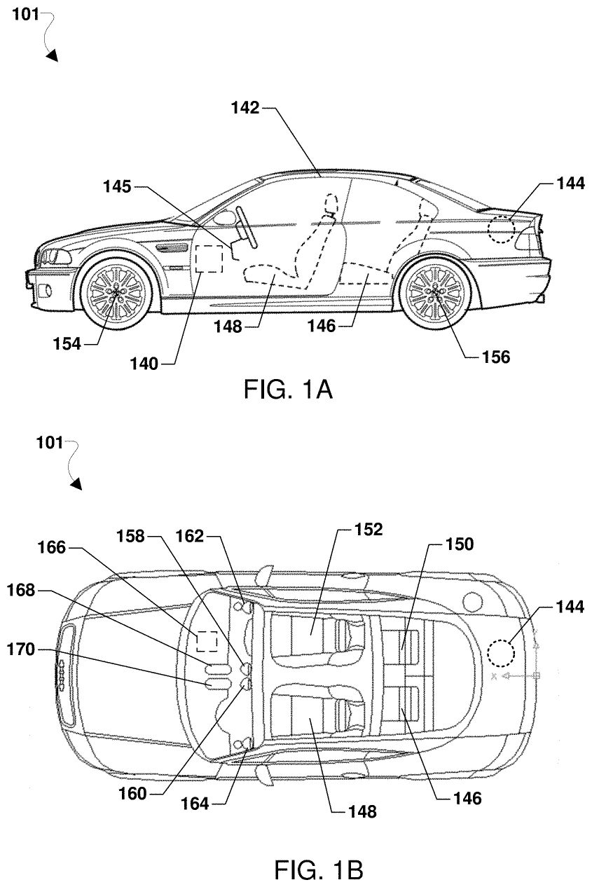

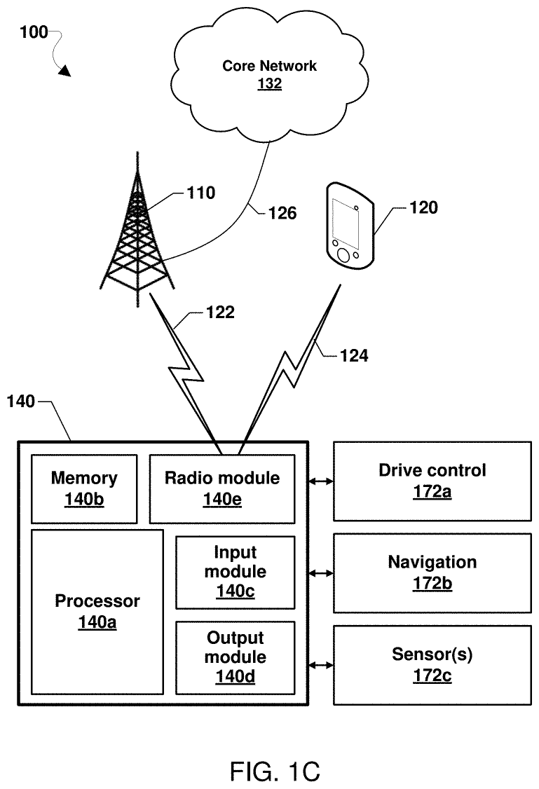

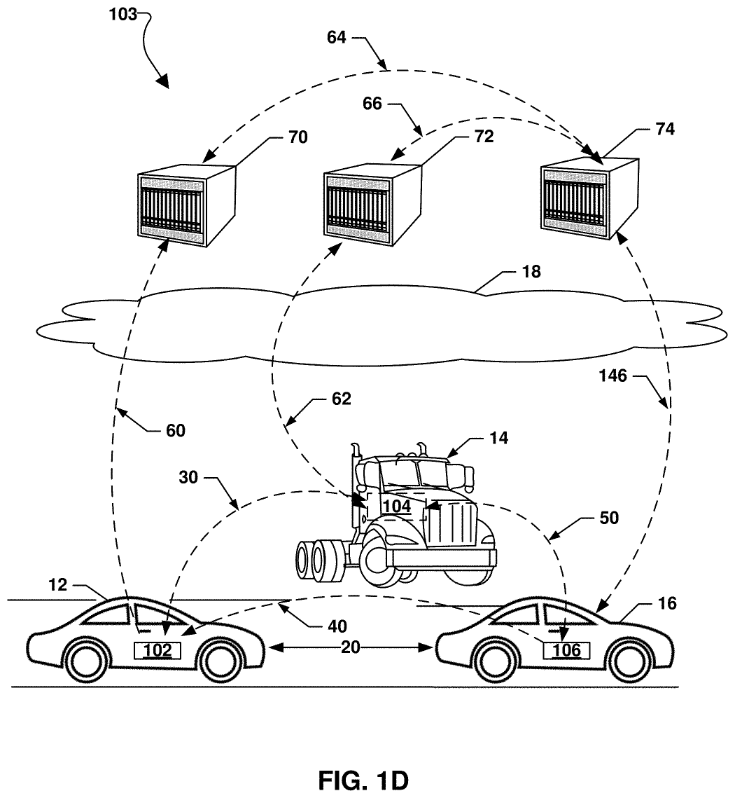

Various embodiments may be implemented within a variety of V2X system participants, an example vehicle 101 of which is illustrated in FIGS. 1A and 1B. With reference to FIGS. 1A and 1B, a vehicle 101 may include a control unit 140 and a plurality of sensors 144-170, including satellite geopositioning system receivers 142, occupancy sensors 144, 146, 148, 150, 152, tire pressure sensors 154, 156, cameras 158, 160, microphones 162, 164, impact sensors 166, radar 168, and lidar 170. The plurality of sensors 144-170, disposed in or on the vehicle, may be used for various purposes, such as autonomous and semi-autonomous navigation and control, crash avoidance, position determination, etc., as well to provide sensor data regarding objects and people in or on the vehicle 101. The sensors 144-170 may include one or more of a wide variety of sensors capable of detecting a variety of information useful for navigation and collision avoidance. Each of the sensors 144-170 may be in wired or wireless communication with a control unit 140, as well as with each other. In particular, the sensors may include one or more cameras 158, 160 or other optical sensors or photo optic sensors. The sensors may further include other types of object detection and ranging sensors, such as radar 168, lidar 170, 1R sensors, and ultrasonic sensors. The sensors may further include tire pressure sensors 154, 156, humidity sensors, temperature sensors, satellite geopositioning sensors 142, control input sensors 145, accelerometers, vibration sensors, gyroscopes, gravimeters, impact sensors 166, force meters, stress meters, strain sensors, fluid sensors, chemical sensors, gas content analyzers, pH sensors, radiation sensors, Geiger counters, neutron detectors, biological material sensors, microphones 162, 164, occupancy sensors 144, 146, 148, 150, 152, proximity sensors, and other sensors.

The vehicle control unit 140 may be configured with processor-executable instructions to perform navigation and collision avoidance operations using information received from various sensors, particularly the cameras 158, 160. In some embodiments, the control unit 140 may supplement the processing of camera images using distance and relative position (e.g., relative bearing angle) that may be obtained from radar 168 and/or lidar 170 sensors. The control unit 140 may further be configured to control steering, breaking and speed of the vehicle 101 when operating in an autonomous or semi-autonomous mode using information regarding other vehicles determined using various embodiments.

FIG. 1C is a component block diagram illustrating a communication system 100 of components and support systems suitable for implementing various embodiments. With reference to FIGS. 1A-IC, a vehicle 101 may include a control unit 140, which may include various circuits and devices used to control the operation of the vehicle 101. In the example illustrated in FIG. 1D the control unit 140 includes a processor 140a, memory 140b, an input module 140c, an output module 140d and a radio module 140e. The control unit 140 may be coupled to and configured to control drive control components 172a, navigation components 172b, and one or more sensors 172c of the vehicle 101. The processor 140a that may be configured with processor-executable instructions to control maneuvering, navigation, and/or other operations of the vehicle 101, including operations of various embodiments. The processor 140a may be coupled to the memory 140b.

The radio module 140e may be configured for wireless communication. The radio module 140e may exchange signals (e.g., command signals for controlling maneuvering, signals from navigation facilities, etc.) via the communication link 122 with a network transceiver (e.g., the base station 110), and may provide the signals to the processor 140a and/or the navigation unit 172b. In some embodiments, the radio module 140e may enable the vehicle 101 to communicate with a wireless communication device 120 through the wireless communication link 124. The wireless communication link 124 may be a bidirectional or unidirectional communication link, and may use one or more communication protocols, as described.

The input module 140c may receive sensor data from one or more vehicle sensors 172c as well as electronic signals from other components, including the drive control components 172a and the navigation components 172b. The output module 140d may communicate with or activate various components of the vehicle 101, including the drive control components 172a, the navigation components 172b, and the sensor(s) 172c.

The control unit 140 may be coupled to the drive control components 172a to control physical elements of the vehicle 101 related to maneuvering and navigation of the vehicle, such as the engine, motors, throttles, steering elements, flight control elements, braking or deceleration elements, and the like. The drive control components 172a may also include components that control other devices of the vehicle, including environmental controls (e.g., air conditioning and heating), external and/or interior lighting, interior and/or exterior informational displays (which may include a display screen or other devices to display information), safety devices (e.g., haptic devices, audible alarms, etc.), and other similar devices.

The control unit 140 may be coupled to the navigation components 172b, and may receive data from the navigation components 172b and be configured to use such data to determine the present position and orientation of the vehicle 101, as well as an appropriate course toward a destination. The navigation components 172b may include or be coupled to a global navigation satellite system (GNSS) receiver system (e.g., one or more Global Positioning System (GPS) receivers) enabling the vehicle 101 to determine its current position using GNSS signals. Alternatively, or in addition, the navigation components 172b may include radio navigation receivers for receiving navigation beacons or other signals from radio nodes, such as Wi-Fi access points, cellular network sites, radio station, remote computing devices, other vehicles, etc. Through control of the drive control elements 172a, the processor 140a may control the vehicle 101 to navigate and maneuver. The processor 140a and/or the navigation components 172b may be configured to communicate with a network element such as a server in a communication network (e.g., the core network 132) via the wireless communication link 122, 126 to receive commands to control maneuvering, receive data useful in navigation, provide real-time position reports, and assess other data.

The control unit 140 may be coupled to one or more sensors 172c. The sensor(s) 172c may include the sensors 144-170 as described, and may the configured to provide a variety of data to the processor 140a.

While the control unit 140 is described as including separate components, in some embodiments some or all of the components (e.g., the processor 140a, the memory 140b, the input module 140c, the output module 140d, and the radio module 140e) may be integrated in a single device or module, such as a system-on-chip (SOC) processing device. Such an SOC processing device may be configured for use in vehicles and be configured, such as with processor-executable instructions executing in the processor 140a, to perform operations of navigation and collision avoidance using local dynamic map (LDM) data when installed in a vehicle.

FIG. 1D illustrates a portion of the V2X system 103 including three vehicles, 12, 14, 16. In the illustrated example, each vehicle 12, 14, 16 includes V2X onboard equipment 102, 104, 106, respectively, that are configured to periodically broadcast Basic Safety Messages 30, 40, 50 for receipt and processing by other vehicles' onboard equipment (e.g., 102, 104, 106). By sharing the vehicle location, speed, direction, braking, and other information, vehicles can maintain safe separation and identify and avoid potential collisions. For example, a trailing vehicle 12 receiving Basic Safety Messages 40 from a leading vehicle 16 can determine the speed and location of the vehicle 16, which in turn enables vehicle 12 to match the speed and maintain a safe separation distance 20. By being informed through Basic Safety Messages 40 when the leading vehicles 16 applies the brakes, the V2X equipment 102 in the trailing vehicle 12 can apply brakes simultaneously to maintain the safe separation distance 20 even when the leading vehicle 16 stops suddenly. As another example, the V2X equipment 104 within the truck vehicle 14 may receive Basic Safety Messages 30, 50 from the two vehicles 12, 16, and thus be informed that the truck vehicle 14 should stop at the intersection to avoid a collision. Each of the vehicle V2X on-board equipment 102, 104, 106 may communicate with one another using any of a variety close proximity communication protocols. In addition, the vehicles may be able to transmit data and information regarding detected Basic Safety Messages as well as detected misbehavior reports to an original equipment manufacturer (OEM) (70, 72) and/or remote misbehavior managing authority 74 via communication links 60, 62 through a communication network 18 (e.g., cellular, WiFi, etc.) The MBR may be transmitted directly to the misbehavior managing authority 74 (e.g., through communication link 64, 66). In other embodiments, the MBR may first be transmitted to a MBR pre-processing unit such as the OEM servers 70, 72 for pre-processing through communication links 64, 66. Then the pre-processed MBR may be transmitted from the MBR pre-processing servers 70, 72 to the misbehavior managing authority 74 through communication links 64, 66. In other embodiments, a MBR may be received from a vehicle, such as from vehicle 16, at the remote misbehavior managing authority 74. The remote misbehavior managing authority 74 may relay the received MBR from the vehicle 16 onto OEM servers 70, 72 via communication links 64, 66. In addition, the OEM servers 70, 72 may provide confirmation reports to the remote misbehavior managing authority 74 via communication links 64, 66.

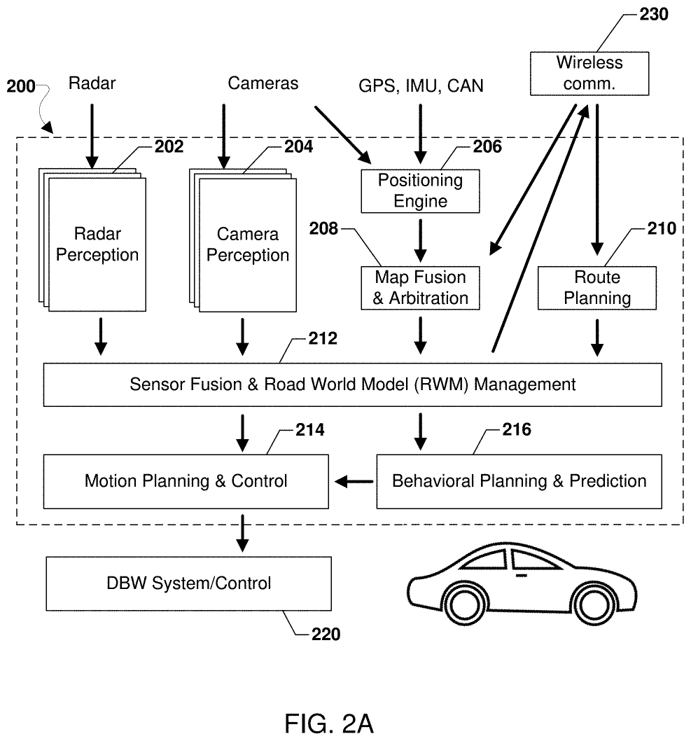

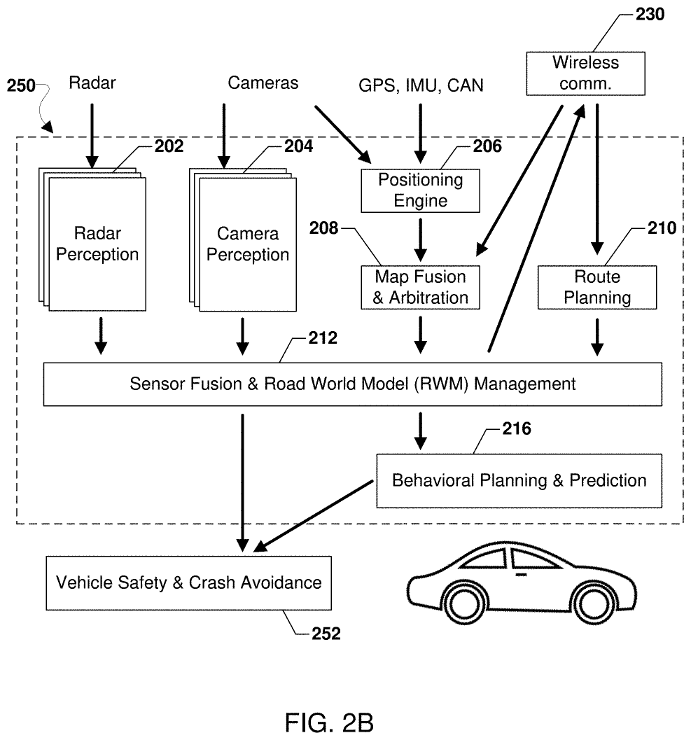

FIG. 2A is a component block diagram illustrating components of an example misbehavior management system 200. The vehicle management system 200 may include various subsystems, communication elements, computational elements, computing devices or units which may be utilized within a vehicle 101. With reference to FIGS. 1A-2A, the various computational elements, computing devices or units within misbehavior management system 200 may be implemented within a system of interconnected computing devices (i.e., subsystems), that communicate data and commands to each other (e.g., indicated by the arrows in FIG. 2A). In some implementations, the various computational elements, computing devices or units within misbehavior management system 200 may be implemented within a single computing device, such as separate threads, processes, algorithms or computational elements. Therefore, each subsystem/computational element illustrated in FIG. 2A is also generally referred to herein as “layer” within a computational “stack” that constitutes the misbehavior management system 200. However, the use of the terms layer and stack in describing various embodiments are not intended to imply or require that the corresponding functionality is implemented within a single autonomous (or semi-autonomous) vehicle management system computing device, although that is a potential implementation embodiment. Rather the use of the term “layer” is intended to encompass subsystems with independent processors, computational elements (e.g., threads, algorithms, subroutines, etc.) running in one or more computing devices, and combinations of subsystems and computational elements.

The misbehavior management system stack may include a radar perception layer 202, a camera perception layer 204, a positioning engine layer 206, a map fusion and arbitration layer 208, a route planning layer 210, sensor fusion and road world model (RWM) management layer 212, motion planning and control layer 214, and behavioral planning and prediction layer 216. The layers 202-216 are merely examples of some layers in one example configuration of the misbehavior management system stack 200. In other configurations, other layers may be included, such as additional layers for other perception sensors (e.g., LIDAR perception layer, etc.), additional layers for planning and/or control, additional layers for modeling, etc., and/or certain of the layers 202-216 may be excluded from the misbehavior management system stack 200. Each of the layers 202-216 may exchange data, computational results and commands as illustrated by the arrows in FIG. 2A. Further, the misbehavior management system stack 200 may receive and process data from sensors (e.g., radar, lidar, cameras, inertial measurement units (IMU) etc.), navigation systems (e.g., GPS receivers, IMUs, etc.), vehicle networks (e.g., Controller Area Network (CAN) bus), and databases in memory (e.g., digital map data). The misbehavior management system stack 200 may output vehicle control commands or signals to the drive by wire (DBW) system/control unit 220, which is a system, subsystem or computing device that interfaces directly with vehicle steering, throttle and brake controls. The configuration of the misbehavior management system stack 200 and DBW system/control unit 220 illustrated in FIG. 2A is merely an example configuration and other configurations of a vehicle management system and other vehicle components may be used. As an example, the configuration of the misbehavior management system stack 200 and DBW system/control unit 220 illustrated in FIG. 2A may be used in a vehicle configured for autonomous or semi-autonomous operation while a different configuration may be used in a non-autonomous vehicle.

The radar perception layer 202 may receive data from one or more detection and ranging sensors, such as radar (e.g., 132) and/or lidar (e.g., 138), and process the data to recognize and determine locations of other vehicles and objects within a vicinity of the vehicle 100. The radar perception layer 202 may include use of neural network processing and artificial intelligence methods to recognize objects and vehicles, and pass such information on to the sensor fusion and RWM management layer 212.

The camera perception layer 204 may receive data from one or more cameras, such as cameras (e.g., 158, 160), and process the data to recognize and determine locations of other vehicles and objects within a vicinity of the vehicle 100. The camera perception layer 204 may include use of neural network processing and artificial intelligence methods to recognize objects and vehicles, and pass such information on to the sensor fusion and RWM management layer 212.

The positioning engine layer 206 may receive data from various sensors and process the data to determine a position of the vehicle 100. The various sensors may include, but is not limited to, GPS sensor, an IMU, and/or other sensors connected via a CAN bus. The positioning engine layer 206 may also utilize inputs from one or more cameras, such as cameras (e.g., 158, 160) and/or any other available sensor, such as radars, LIDARs, etc.

The misbehavior management system 200 may include or be coupled to a vehicle wireless communication subsystem 230. The wireless communication subsystem 230 may be configured to communicate with other vehicle computing devices and highway communication systems, such as via vehicle-to-vehicle (V2V) communication links and/or to remote information sources, such as cloud-based resources, via cellular wireless communication systems, such as 5G networks. In various embodiments, the wireless communication subsystem 230 may communicate with other V2X system participants via wireless communication links to receive V2X messages as well as sensor data that may support a conclusion that a misbehavior condition is detected.

The map fusion and arbitration layer 208 may access sensor data received from other V2X system participants and receive output received from the positioning engine layer 206 and process the data to further determine the position of the vehicle 101 within the map, such as location within a lane of traffic, position within a street map, etc. sensor data may be stored in a memory (e.g., memory 312). For example, the map fusion and arbitration layer 208 may convert latitude and longitude information from GPS into locations within a surface map of roads contained in the sensor data. GPS position fixes include errors, so the map fusion and arbitration layer 208 may function to determine a best guess location of the vehicle within a roadway based upon an arbitration between the GPS coordinates and the sensor data. For example, while GPS coordinates may place the vehicle near the middle of a two-lane road in the sensor data, the map fusion and arbitration layer 208 may determine from the direction of travel that the vehicle is most likely aligned with the travel lane consistent with the direction of travel. The map fusion and arbitration layer 208 may pass map-based location information to the sensor fusion and RWM management layer 212.

The route planning layer 210 may utilize sensor data, as well as inputs from an operator or dispatcher to plan a route to be followed by the vehicle 101 to a particular destination. The route planning layer 210 may pass map-based location information to the sensor fusion and RWM management layer 212. However, the use of a prior map by other layers, such as the sensor fusion and RWM management layer 212, etc., is not required. For example, other stacks may operate and/or control the vehicle based on perceptual data alone without a provided map, constructing lanes, boundaries, and the notion of a local map as perceptual data is received.

The sensor fusion and RWM management layer 212 may receive data and outputs produced by the radar perception layer 202, camera perception layer 204, map fusion and arbitration layer 208, and route planning layer 210, and use some or all of such inputs to estimate or refine the location and state of the vehicle 101 in relation to the road, other vehicles on the road, and other objects within a vicinity of the vehicle 100. For example, the sensor fusion and RWM management layer 212 may combine imagery data from the camera perception layer 204 with arbitrated map location information from the map fusion and arbitration layer 208 to refine the determined position of the vehicle within a lane of traffic. As another example, the sensor fusion and RWM management layer 212 may combine object recognition and imagery data from the camera perception layer 204 with object detection and ranging data from the radar perception layer 202 to determine and refine the relative position of other vehicles and objects in the vicinity of the vehicle. As another example, the sensor fusion and RWM management layer 212 may receive information from vehicle-to-vehicle (V2V) communications (such as via the CAN bus) regarding other vehicle positions and directions of travel, and combine that information with information from the radar perception layer 202 and the camera perception layer 204 to refine the locations and motions of other vehicles. The sensor fusion and RWM management layer 212 may output refined location and state information of the vehicle 100, as well as refined location and state information of other vehicles and objects in the vicinity of the vehicle, to the motion planning and control layer 214 and/or the behavior planning and prediction layer 216.

As a further example, the sensor fusion and RWM management layer 212 may use dynamic traffic control instructions directing the vehicle 101 to change speed, lane, direction of travel, or other navigational element(s), and combine that information with other received information to determine refined location and state information. The sensor fusion and RWM management layer 212 may output the refined location and state information of the vehicle 101, as well as refined location and state information of other vehicles and objects in the vicinity of the vehicle 100, to the motion planning and control layer 214, the behavior planning and prediction layer 216 and/or devices remote from the vehicle 101, such as a data server, other vehicles, etc., via wireless communications, such as through C-V2X connections, other wireless connections, etc.

As a still further example, the sensor fusion and RWM management layer 212 may monitor perception data from various sensors, such as perception data from a radar perception layer 202, camera perception layer 204, other perception layer, etc., and/or data from one or more sensors themselves to analyze conditions in the vehicle sensor data. The sensor fusion and RWM management layer 212 may be configured to detect conditions in the sensor data, such as sensor measurements being at, above, or below a threshold, certain types of sensor measurements occurring, etc., and may output the sensor data as part of the refined location and state information of the vehicle 101 provided to the behavior planning and prediction layer 216 and/or devices remote from the vehicle 100, such as a data server, other vehicles, etc., via wireless communications, such as through C-V2X connections, other wireless connections, etc.

The refined location and state information may include vehicle descriptors associated with the vehicle and the vehicle owner and/or operator, such as: vehicle specifications (e.g., size, weight, color, on board sensor types, etc.); vehicle position, speed, acceleration, direction of travel, attitude, orientation, destination, fuel/power level(s), and other state information; vehicle emergency status (e.g., is the vehicle an emergency vehicle or private individual in an emergency); vehicle restrictions (e.g., heavy/wide load, turning restrictions, high occupancy vehicle (HOV) authorization, etc.); capabilities (e.g., all-wheel drive, four-wheel drive, snow tires, chains, connection types supported, on board sensor operating statuses, on board sensor resolution levels, etc.) of the vehicle; equipment problems (e.g., low tire pressure, weak breaks, sensor outages, etc.); owner/operator travel preferences (e.g., preferred lane, roads, routes, and/or destinations, preference to avoid tolls or highways, preference for the fastest route, etc.); permissions to provide sensor data to a data agency server (e.g., 184); and/or owner/operator identification information.

The behavioral planning and prediction layer 216 of the autonomous vehicle system stack 200 may use the refined location and state information of the vehicle 101 and location and state information of other vehicles and objects output from the sensor fusion and RWM management layer 212 to predict future behaviors of other vehicles and/or objects. For example, the behavioral planning and prediction layer 216 may use such information to predict future relative positions of other vehicles in the vicinity of the vehicle based on own vehicle position and velocity and other vehicle positions and velocity. Such predictions may take into account information from the LDM data and route planning to anticipate changes in relative vehicle positions as host and other vehicles follow the roadway. The behavioral planning and prediction layer 216 may output other vehicle and object behavior and location predictions to the motion planning and control layer 214. Additionally, the behavior planning and prediction layer 216 may use object behavior in combination with location predictions to plan and generate control signals for controlling the motion of the vehicle 101. For example, based on route planning information, refined location in the roadway information, and relative locations and motions of other vehicles, the behavior planning and prediction layer 216 may determine that the vehicle 101 needs to change lanes and accelerate, such as to maintain or achieve minimum spacing from other vehicles, and/or prepare for a turn or exit. As a result, the behavior planning and prediction layer 216 may calculate or otherwise determine a steering angle for the wheels and a change to the throttle setting to be commanded to the motion planning and control layer 214 and DBW system/control unit 220 along with such various parameters necessary to effectuate such a lane change and acceleration. One such parameter may be a computed steering wheel command angle.

The motion planning and control layer 214 may receive data and information outputs from the sensor fusion and RWM management layer 212 and other vehicle and object behavior as well as location predictions from the behavior planning and prediction layer 216, and use this information to plan and generate control signals for controlling the motion of the vehicle 101 and to verify that such control signals meet safety requirements for the vehicle 100. For example, based on route planning information, refined location in the roadway information, and relative locations and motions of other vehicles, the motion planning and control layer 214 may verify and pass various control commands or instructions to the DBW system/control unit 220.

The DBW system/control unit 220 may receive the commands or instructions from the motion planning and control layer 214 and translate such information into mechanical control signals for controlling wheel angle, brake and throttle of the vehicle 100. For example, DBW system/control unit 220 may respond to the computed steering wheel command angle by sending corresponding control signals to the steering wheel controller.

In various embodiments, the wireless communication subsystem 230 may communicate with other V2X system participants via wireless communication links to transmit sensor data, position data, vehicle data and data gathered about the environment around the vehicle by onboard sensors. Such information may be used by other V2X system participants to update stored sensor data for relay to other V2X system participants.

In various embodiments, the misbehavior management system stack 200 may include functionality that performs safety checks or oversight of various commands, planning or other decisions of various layers that could impact vehicle and occupant safety. Such safety check or oversight functionality may be implemented within a dedicated layer or distributed among various layers and included as part of the functionality. In some embodiments, a variety of safety parameters may be stored in memory and the safety checks or oversight functionality may compare a determined value (e.g., relative spacing to a nearby vehicle, distance from the roadway centerline, etc.) to corresponding safety parameter(s), and issue a warning or command if the safety parameter is or will be violated. For example, a safety or oversight function in the behavior planning and prediction layer 216 (or in a separate layer) may determine the current or future separate distance between another vehicle (as defined by the sensor fusion and RWM management layer 212) and the vehicle (e.g., based on the world model refined by the sensor fusion and RWM management layer 212), compare that separation distance to a safe separation distance parameter stored in memory, and issue instructions to the motion planning and control layer 214 to speed up, slow down or turn if the current or predicted separation distance violates the safe separation distance parameter. As another example, safety or oversight functionality in the motion planning and control layer 214 (or a separate layer) may compare a determined or commanded steering wheel command angle to a safe wheel angle limit or parameter, and issue an override command and/or alarm in response to the commanded angle exceeding the safe wheel angle limit.

Some safety parameters stored in memory may be static (i.e., unchanging over time), such as maximum vehicle speed. Other safety parameters stored in memory may be dynamic in that the parameters are determined or updated continuously or periodically based on vehicle state information and/or environmental conditions. Non-limiting examples of safety parameters include maximum safe speed, maximum brake pressure, maximum acceleration, and the safe wheel angle limit, all of which may be a function of roadway and weather conditions.

FIG. 2B illustrates an example of subsystems, computational elements, computing devices or units within a vehicle management system 250, which may be utilized within a vehicle 101. With reference to FIGS. 1A-2B, in some embodiments, the layers 202, 204, 206, 208, 210, 212, and 216 of the misbehavior management system stack 200 may be similar to those described with reference to FIG. 2A and the misbehavior management system stack 250 may operate similar to the misbehavior management system stack 200, except that the misbehavior management system stack 250 may pass various data or instructions to a vehicle safety and crash avoidance system 252 rather than the DBW system/control unit 220. For example, the configuration of the misbehavior management system stack 250 and the vehicle safety and crash avoidance system 252 illustrated in FIG. 2B may be used in a non-autonomous vehicle.

In various embodiments, the behavioral planning and prediction layer 216 and/or sensor fusion and RWM management layer 212 may output data to the vehicle safety and crash avoidance system 252. For example, the sensor fusion and RWM management layer 212 may output sensor data as part of refined location and state information of the vehicle 101 provided to the vehicle safety and crash avoidance system 252. The vehicle safety and crash avoidance system 252 may use the refined location and state information of the vehicle 101 to make safety determinations relative to the vehicle 101 and/or occupants of the vehicle 100. As another example, the behavioral planning and prediction layer 216 may output behavior models and/or predictions related to the motion of other vehicles to the vehicle safety and crash avoidance system 252. The vehicle safety and crash avoidance system 252 may use the behavior models and/or predictions related to the motion of other vehicles to make safety determinations relative to the vehicle 101 and/or occupants of the vehicle 101.

In various embodiments, the vehicle safety and crash avoidance system 252 may include functionality that performs safety checks or oversight of various commands, planning, or other decisions of various layers, as well as human driver actions, that could impact vehicle and occupant safety. In some embodiments, a variety of safety parameters may be stored in memory and the vehicle safety and crash avoidance system 252 may compare a determined value (e.g., relative spacing to a nearby vehicle, distance from the roadway centerline, etc.) to corresponding safety parameter(s), and issue a warning or command if the safety parameter is or will be violated. For example, a vehicle safety and crash avoidance system 252 may determine the current or future separate distance between another vehicle (as defined by the sensor fusion and RWM management layer 212) and the vehicle (e.g., based on the world model refined by the sensor fusion and RWM management layer 212), compare that separation distance to a safe separation distance parameter stored in memory, and issue instructions to a driver to speed up, slow down or turn if the current or predicted separation distance violates the safe separation distance parameter. As another example, a vehicle safety and crash avoidance system 252 may compare a human driver's change in steering wheel angle to a safe wheel angle limit or parameter, and issue an override command and/or alarm in response to the steering wheel angle exceeding the safe wheel angle limit.

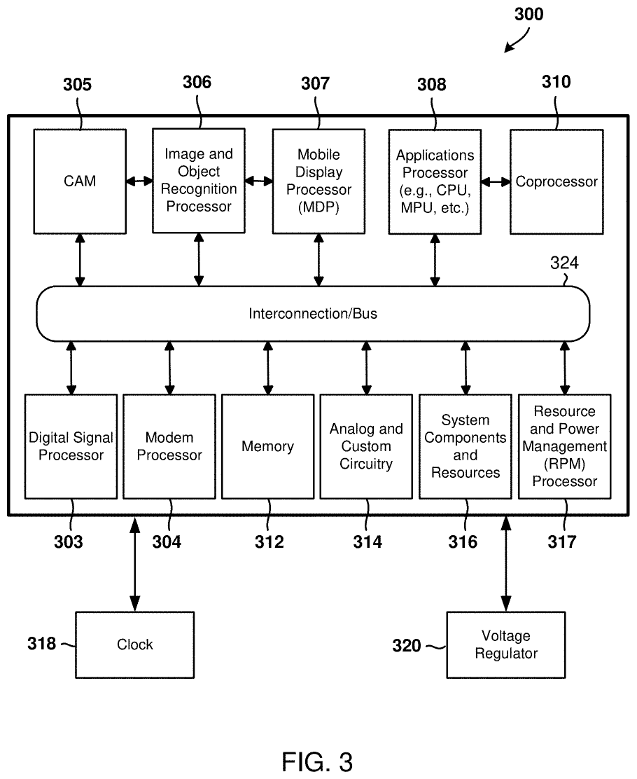

FIG. 3 illustrates an example system-on-chip (SOC) architecture of a processing device SOC 300 suitable for implementing various embodiments in vehicles. With reference to FIGS. 1A-3, the processing device SOC 300 may include a number of heterogeneous processors, such as a digital signal processor (DSP) 303, a modem processor 304, an image and object recognition processor 306, a mobile display processor 307, an applications processor 308, and a resource and power management (RPM) processor 317. The processing device SOC 300 may also include one or more coprocessors 310 (e.g., vector co-processor) connected to one or more of the heterogeneous processors 303, 304, 306, 307, 308, 317. Each of the processors may include one or more cores, and an independent/internal clock. Each processor/core may perform operations independent of the other processors/cores. For example, the processing device SOC 300 may include a processor that executes a first type of operating system (e.g., FreeBSD, LINUX, OS X, etc.) and a processor that executes a second type of operating system (e.g., Microsoft Windows). In some embodiments, the applications processor 308 may be the SOC's 300 main processor, central processing unit (CPU), microprocessor unit (MPU), arithmetic logic unit (ALU), etc. The graphics processor 306 may be graphics processing unit (GPU).

The processing device SOC 300 may include analog circuitry and custom circuitry 314 for managing sensor data, analog-to-digital conversions, wireless data transmissions, and for performing other specialized operations, such as processing encoded audio and video signals for rendering in a web browser. The processing device SOC 300 may further include system components and resources 316, such as voltage regulators, oscillators, phase-locked loops, peripheral bridges, data controllers, memory controllers, system controllers, access ports, timers, and other similar components used to support the processors and software clients (e.g., a web browser) running on a computing device.

The processing device SOC 300 also include specialized circuitry for camera actuation and management (CAM) 305 that includes, provides, controls and/or manages the operations of one or more cameras 158, 160 (e.g., a primary camera, webcam, 3D camera, etc.), the video display data from camera firmware, image processing, video preprocessing, video front-end (VFE), in-line JPEG, high definition video codec, etc. The CAM 305 may be an independent processing unit and/or include an independent or internal clock.

In some embodiments, the image and object recognition processor 306 may be configured with processor-executable instructions and/or specialized hardware configured to perform image processing and object recognition analyses involved in various embodiments. For example, the image and object recognition processor 306 may be configured to perform the operations of processing images received from cameras (e.g., 158, 160) via the CAM 305 to recognize and/or identify other vehicles, and otherwise perform functions of the camera perception layer 204 as described. In some embodiments, the processor 306 may be configured to process radar or lidar data and perform functions of the radar perception layer 202 as described.

The system components and resources 316, analog and custom circuitry 314, and/or CAM 305 may include circuitry to interface with peripheral devices, such as cameras 158, 160, radar 168, lidar 170, electronic displays, wireless communication devices, external memory chips, etc. The processors 303, 304, 306, 307, 308 may be interconnected to one or more memory elements 312, system components and resources 316, analog and custom circuitry 314, CAM 305, and RPM processor 317 via an interconnection/bus module 324, which may include an array of reconfigurable logic gates and/or implement a bus architecture (e.g., CoreConnect, AMBA, etc.). Communications may be provided by advanced interconnects, such as high-performance networks-on chip (NoCs).

The processing device SOC 300 may further include an input/output module (not illustrated) for communicating with resources external to the SOC, such as a clock 318 and a voltage regulator 320. Resources external to the SOC (e.g., clock 318, voltage regulator 320) may be shared by two or more of the internal SOC processors/cores (e.g., a DSP 303, a modem processor 304, a graphics processor 306, an applications processor 308, etc.).

In some embodiments, the processing device SOC 300 may be included in a control unit (e.g., 140) for use in a vehicle (e.g., 100). The control unit may include communication links for communication with a telephone network (e.g., 180), the Internet, and/or a network server (e.g., 184) as described.

The processing device SOC 300 may also include additional hardware and/or software components that are suitable for collecting sensor data from sensors, including motion sensors (e.g., accelerometers and gyroscopes of an IMU), user interface elements (e.g., input buttons, touch screen display, etc.), microphone arrays, sensors for monitoring physical conditions (e.g., location, direction, motion, orientation, vibration, pressure, etc.), cameras, compasses, GPS receivers, communications circuitry (e.g., Bluetooth®, WLAN, WiFi, etc.), and other well-known components of modern electronic devices.

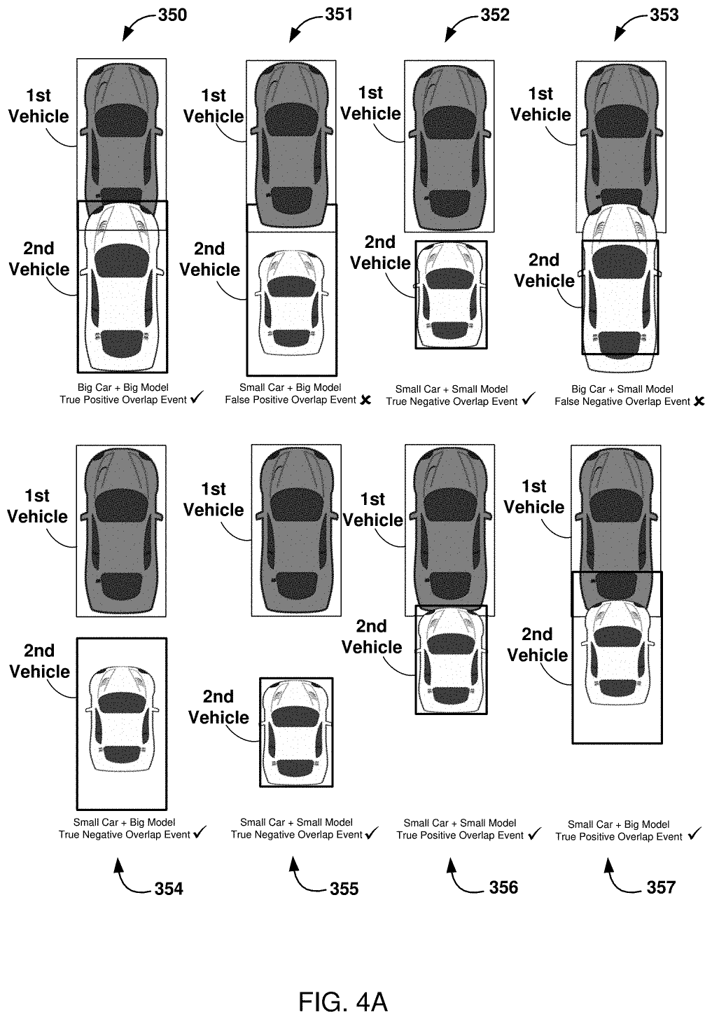

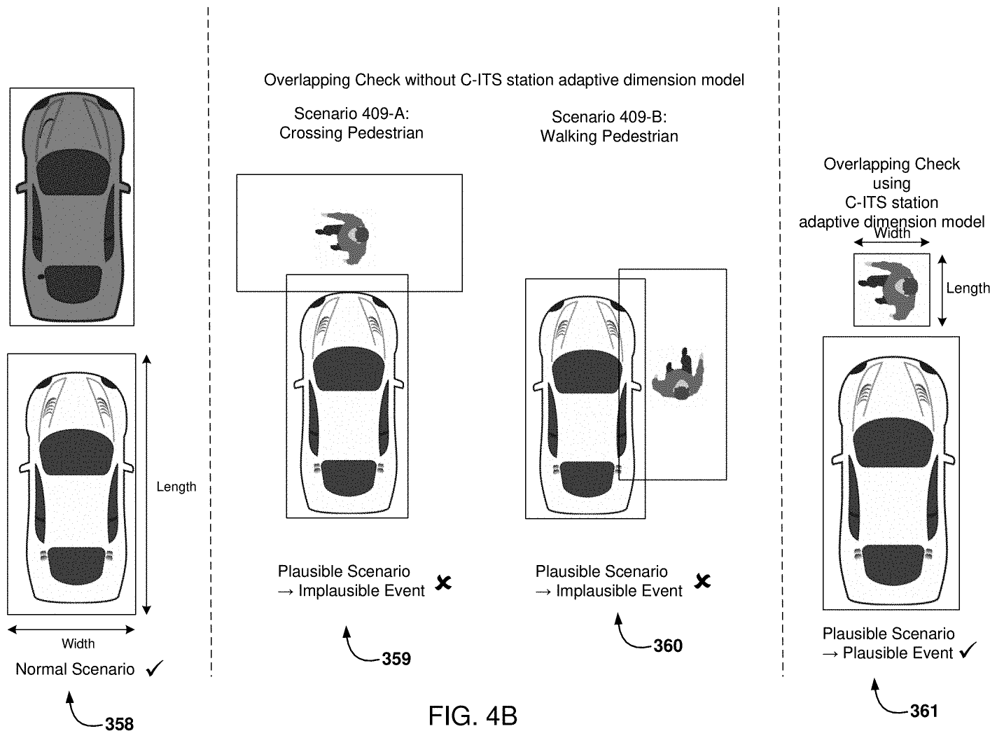

In order to minimize the possible dimension values to calculate a possible position overlap misbehavior condition, a V2X system participant processor may assign threshold vehicle model data to a second vehicle. However, if the dimensional values do not accurately represent the second vehicle, the detection of a position overlap misbehavior condition may be a false positive condition. FIG. 4A illustrates a number of example scenarios that may occur when an accurate threshold vehicle model is chosen and an inaccurate threshold vehicle model is chosen and resulting conclusions from such selections. In each of the scenarios that are illustrated the first vehicle (e.g., reporting vehicle) is illustrated in the “top” position, the second vehicle (e.g., neighboring vehicle) is illustrated in the “bottom” position.

With reference to FIGS. 1A-4A, in each of scenarios 350-357, the first vehicle may use hardcoded of default values for the first vehicle length and first vehicle length. In other embodiments, the first vehicle may assign first vehicle length and a first vehicle width based on a selected threshold vehicle model. In the example illustrated in scenario 350, the second vehicle is a “big” vehicle that is assigned a “big” threshold vehicle model, and the reported positions of the first vehicle and the second vehicle, at least one of which is inaccurate, result in a position overlap. Thus, in scenario 350, a position overlap misbehavior condition has occurred (unless the second vehicle truly is partially within the trunk of the first vehicle, such as following a collision). The first vehicle and the second vehicle are determined to be positioned too close to one another and the first and second vehicles are assigned accurate dimensions from the selected threshold vehicle model set. Thus, the overlap misbehavior condition that has been detected may be a positive misbehavior event with a high confidence value the dimensional boundaries of the two vehicles overlap. This scenario may be considered a true positive event. Put another way, it is a positive event because the first vehicle and second vehicle have been detected to overlap in position and it is a true positive because in the “real world/ground truth” there is indeed a position overlap.

In the example illustrated in scenario 351, the second vehicle is a “small” vehicle that is inaccurately assigned a “big” threshold vehicle model. Thus, the second vehicle is assigned inaccurate dimensions from the selected threshold vehicle model set. Thus, in scenario 351, a false positive position overlap misbehavior condition may have occurred. Although the first vehicle and the second vehicle are properly positioned from one another to avoid a position overlap, the second vehicle is assigned inaccurate dimensions from a “big” threshold vehicle model. Thus, a position overlap misbehavior condition has been detected, but the detected position overlap misbehavior condition is a false positive event. Put another way, it is a positive event because the first vehicle and second vehicle have been detected to overlap in position. However, it is a false positive event because in the “real world/ground truth” there is not a position overlap

In the example illustrated in scenario 352, the second vehicle is a “small” vehicle that is accurately assigned a “small” threshold vehicle model. Thus, the second vehicle is assigned accurate dimensions from the selected threshold vehicle model set. Thus, in scenario 352, no position overlap is detected. In scenario 352, the first vehicle and the second vehicle are properly positioned from one another to avoid a position overlap, the second vehicle is assigned accurate dimensions from a “small” threshold vehicle model. Thus, a position overlap misbehavior condition has not been detected, which is a true negative event. Put another way, it is a negative event because the first vehicle and second vehicle have been detected to not overlap in position and it is a true negative because in the “real world/round truth” there is indeed no position overlap.

In the example illustrated in scenario 353, the second vehicle is a “big” vehicle that is inaccurately assigned a “small” threshold vehicle model. Thus, the second vehicle is assigned inaccurate dimensions from the selected threshold vehicle model set. Thus, in scenario 353, a false negative position overlap misbehavior condition may have occurred. In scenario 353, the first vehicle and the second vehicle are improperly positioned from one another such that a position overlap would be detected if true dimensions were applied to both vehicles. However, since the second vehicle is assigned inaccurate dimensions from a “small” threshold vehicle model, a position overlap misbehavior condition has not been detected, which is a false negative event. Put another way, it is a negative event because the first vehicle and second vehicle have been detected to not overlap in position. However, it is a false negative because in the “real world/ground truth” there is indeed position overlap.

In the example illustrated in scenario 354, the second vehicle is a “small” vehicle that is inaccurately assigned a “big” threshold vehicle model. Thus, the second vehicle is assigned inaccurate dimensions from the selected threshold vehicle model set. However, the vehicles are positioned sufficiently far apart such that there is no positional overlap, even though the bounding dimensions of the second vehicle are incorrect. Thus, in scenario 354, a true negative position overlap condition has occurred. In scenario 354, the first vehicle and the second vehicle are properly positioned from one another to avoid a position overlap, even though the second vehicle is assigned inaccurate dimensions from a “big” threshold vehicle model. Despite the inaccurate dimensions assigned to the “small” vehicle, a position overlap misbehavior condition has not been detected, and the non-detection of a position overlap condition is a true negative event. Put another way, it is a negative event because the first vehicle and second vehicle have been detected to not overlap in position and it is a true negative because in the “real world/ground truth” there is indeed no position overlap.

In the example illustrated in scenario 355, the second vehicle is a “small” vehicle that is accurately assigned a “small” threshold vehicle model, and the second vehicle is assigned accurate dimensions from the selected threshold vehicle model set. Thus, in scenario 355, a true negative position overlap condition has occurred. In scenario 355, the first vehicle and the second vehicle are properly positioned from one another to avoid a position overlap, the second vehicle is assigned accurate dimensions from a “small” threshold vehicle model. Thus, a position overlap misbehavior condition has not been detected, the non-detection of a position overlap condition is a true negative event. Put another way, it is a negative event because the first vehicle and second vehicle have been detected to not overlap in position and it is a true negative because in the “real world/ground truth” there is indeed no position overlap.

In the example illustrated in scenario 356, the second vehicle is a “small” vehicle that is accurately assigned a “small” threshold vehicle model. Thus, the second vehicle is assigned accurate dimensions from the selected threshold vehicle model set. Thus, in scenario 356, a true positive position overlap condition may have occurred. In scenario 356, the first vehicle and the second vehicle are improperly positioned from one another to result in a position overlap, the second vehicle is assigned accurate dimensions from a “small” threshold vehicle model. Thus, a position overlap misbehavior condition has been detected, the detection of a position overlap condition is a true positive event. Put another way, it is a positive event because the first vehicle and second vehicle have been detected to overlap in position and it is a true positive because in the “real world/ground truth” there is indeed a position overlap.

In the example illustrated in scenario 357, the second vehicle is a “small” vehicle that is inaccurately assigned a “big” threshold vehicle model. However, despite being assigned inaccurate and large dimensions, the second vehicle is positioned too close to the first vehicle to result in a position overlap misbehavior condition. Thus, in scenario 357, a true positive position overlap condition may have occurred. In scenario 357, the first vehicle and the second vehicle are improperly positioned from one another to result in a position overlap, the second vehicle is assigned inaccurate dimensions from a “big” threshold vehicle model. Despite the inaccurate dimension assignment, a position overlap misbehavior condition has been detected, the detection of a position overlap condition is a true positive event. Put another way, it is a positive event because the first vehicle and second vehicle have been detected to overlap in position and it is a true positive because in the “real world/ground truth” there is indeed a position overlap.

FIG. 4B illustrates additional examples of position overlap misbehavior condition detection anomalies that may occur when inaccurate dimensions are assigned to other V2X system participants, such as a pedestrian. With reference to FIGS. 1A-4B, in the example illustrated in scenario 358, similar to scenario 354, the second vehicle is a “big” vehicle that is accurately assigned a “big” threshold vehicle model. Thus, the second vehicle is assigned accurate dimensions from the selected threshold vehicle model set. In scenario 354, the first vehicle and the second vehicle are properly positioned from one another to avoid a position overlap, the second vehicle is assigned accurate dimensions from a “big” threshold vehicle model. Thus, in scenario 358, a true negative position overlap condition may have occurred.

In scenarios 359 and 360, the other V2X system participant may be a pedestrian that is carrying a mobile device capable of communicating through the V2X system. As a pedestrian, the entity may have actual dimensions shorter in length and narrower in width than that of the smallest car in a current geographic area. Nevertheless, the pedestrian (i.e., second vehicle) may be considered a “small vehicle” that is inaccurately assigned a “big” threshold vehicle model. Thus, the second vehicle is assigned inaccurate dimensions from the selected threshold vehicle model set. Thus, in scenarios 359 and 360, a false positive position overlap condition may be detected. In scenarios 359 and 360, the first vehicle and the “second vehicle” are properly positioned from one another to avoid a position overlap. However, since the “second vehicle” is assigned inaccurate dimensions from a “big” threshold vehicle model, the V2X system participant processor would detect a position overlap misbehavior condition has occurred. Thus, while a position overlap misbehavior condition has been detected, the detection of the position overlap condition is a false positive event.

In vehicle may be a “scenario 361, the other V2X system participant may be a pedestrian that is carrying a mobile device capable of communicating through the V2X system. As a pedestrian, the entity may have actual dimensions shorter in length and narrower in width than that of the smallest car in a current geographic area. In some instances, the pedestrian (i.e., second vehicle) may be considered a “small vehicle” that is accurately assigned a “small” threshold vehicle model. Thus, the second vehicle is assigned accurate dimensions from the selected threshold vehicle model set. Thus, in scenario 361, a true negative position overlap condition may be detected. In scenario 361, the first vehicle and the “second vehicle” are properly positioned from one another to avoid a position overlap. In addition, since the “second vehicle” is assigned accurate dimensions from a “small” threshold vehicle model, the V2X system participant processor would not detect a position overlap misbehavior condition has occurred. Since a position overlap misbehavior condition has not been detected, the non-detection of the position overlap condition is a true negative event.

The various scenarios shown in FIGS. 4A and 4B illustrate a need to accurately represent the dimensions of the vehicles in a V2X system. While a solution to the need to accurately represent the dimensions of the vehicles in a V2X system may be to store each individual set of dimensions for each model and variant of a vehicle known to the V2X system. However, such a solution may not be efficient or permissive in a V2X system with limited resources. The scenarios shown in FIGS. 4A and 4B illustrate that even in instances in which a “big” vehicle is inaccurately assigned dimensions from a “small” vehicle threshold model, a false negative position overlap event may occur. In instances in which a “small” vehicle is inaccurately assigned dimensions from a “big” vehicle threshold model, a false positive position overlap event may occur. Such false positive and false negative event occurrences may result in distrust of the V2X system and defeats the purpose of intelligent transport systems (ITS).

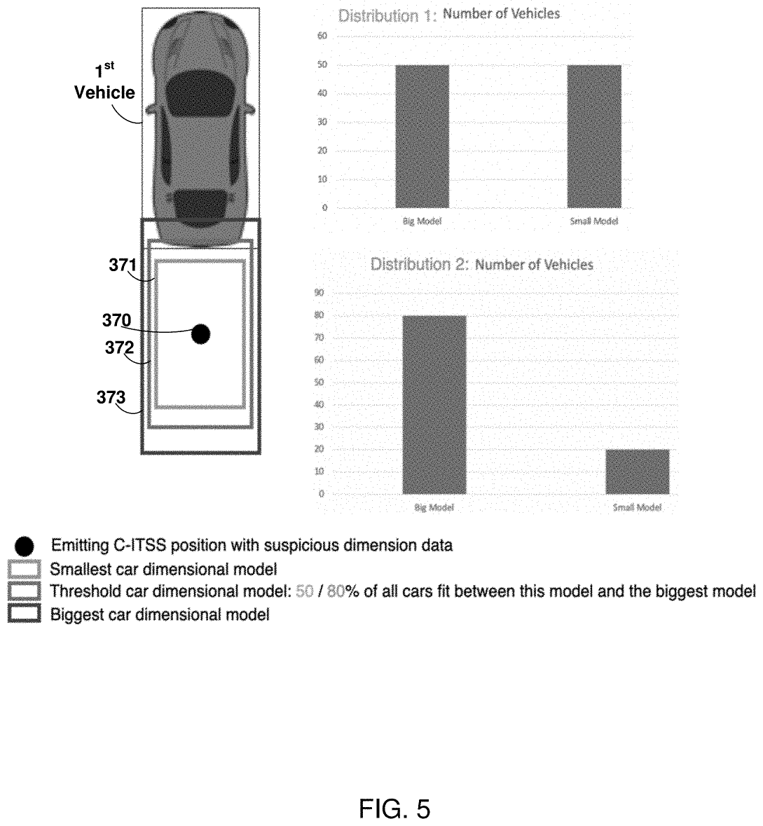

FIG. 5 illustrates more accurate vehicle threshold models for use with various embodiment methods disclosed herein. The vehicle threshold models illustrated in FIG. 5 may improve the accuracy of position overlap misbehavior condition detection. In addition, the vehicle threshold models illustrated in FIG. 5 may provide a V2X system with information to calculate a confidence level of a detection of a position overlap misbehavior condition. With reference to FIGS. 1A-5, a first vehicle (e.g., reporting vehicle) is illustrated. A dot 370 represents the reported position of a second vehicle that has a “parallel” orientation with respect to the first vehicle. This position and orientation (i.e., heading) data may be reported by the second vehicle in a V2X message based on sensor data contained in the second vehicle. In addition, such position and orientation data may be confirmed by first vehicle sensor data such as radar and camera sensor data equipped on the first vehicle. For purposes of performing a position overlap check, the first vehicle may assign dimensions to the second vehicle by selecting an appropriate vehicle threshold model.

FIG. 5 illustrates a set of vehicle threshold models containing three different vehicle threshold models. A minimum vehicle threshold model 371 may assign the shortest length and narrowest width dimensions (i.e., minimum dimensions) to the second vehicle. A maximum vehicle threshold model 373 may assign a length greater than the actual longest vehicle length (e.g., maximum vehicle length) and width greater than the actual widest vehicle width dimensions (e.g., maximum vehicle width) (i.e., collectively maximum dimensions) to the second vehicle. Conversely, in other embodiments, the minimum vehicle threshold model 371 may assign to the second vehicle a length less than the actual shortest length vehicle (i.e., minimum vehicle length) and a width less the actual narrowest vehicle width dimensions (e.g., minimum vehicle width) (i.e., collectively minimum dimensions). A maximum vehicle threshold model 373 may assign to the second vehicle a length of the actual longest vehicle length (e.g., maximum vehicle length) and width of the actual widest vehicle width dimensions (e.g., maximum vehicle width) (i.e., collectively maximum dimensions). In doing so, the system may provide some “buffer” to the dimensions of even the largest vehicle in a current geographic area. A vehicle threshold model 372 may assign a length that is shorter that the maximum length but longer than the minimum length. In addition, vehicle threshold model 372 may assign a width that is narrower than the maximum width but wider than the minimum width.

Further, each of the minimum vehicle threshold model 371, maximum vehicle threshold model 373 and vehicle threshold model 372 may contain a “confidence value” associated with the dimensions of each of the minimum vehicle threshold model 371, maximum vehicle threshold model 373 and vehicle threshold model 372. The confidence value associated with the various assigned dimensions may be based on the distribution of vehicles in a current geographic area. In some embodiments, the confidence value may be expressed as the total percentage of all vehicles minus the percentage of vehicles larger than the assigned dimensions in the selected vehicle threshold model. In some embodiments, the confidence value may be expressed as the total percentage of all vehicles minus the percentage of vehicles smaller than the assigned dimensions in the selected vehicle threshold model. For example, the confidence value may be between 0 and 1 (or 0% and 100%).

For example, in a geographic area (e.g., country, state, county, city, town, etc.) in which there is a single car model, there is no need for more than one vehicle threshold model in the set of vehicle threshold models. A singular vehicle threshold model may be implemented, in which all of the known possible vehicles share the same dimensions as assigned by the vehicle threshold model. Since the distribution of the cars in the current geographic area are all of the same model, the confidence value of the maximum vehicle threshold model 373 may be 1 (i.e., the total percentage of all vehicles in the current geographic area=1 (100%) minus the percentage of vehicles larger than the assigned dimensions in the selected vehicle threshold model=0). The confidence value of the minimum vehicle threshold model 371 may be zero (0) or 0% (i.e., the total percentage of all vehicles in the current geographic area=1 (100%) minus the percentage of vehicles larger than the assigned dimensions in the selected vehicle threshold model=1 (100%), thus 1−1=0).

A calculated confidence level of a position overlap misbehavior detection may be expressed as the percentage of vehicles smaller than the maximum dimensions minus the confidence value of the selected vehicle threshold. In various embodiments, the calculated confidence level may be between zero (0) and one (1) (i.e., 0%-100%). Thus, a calculated confidence level of a detected position overlap misbehavior using the maximum vehicle threshold model 373 may be zero (0) or 0% (i.e., 1−1=0) since any position overlap misbehavior condition using dimensions larger than the dimensions of the singular vehicle model would result in a false positive event. As noted above, such false positives may erode at the trust of the V2X system. However, a calculated confidence level of a detected position overlap misbehavior using the minimum vehicle threshold model 371 may be 1 or 100% (i.e., 1−0=1) since any position overlap misbehavior condition using the minimum dimensions (i.e., dimensions of the singular vehicle model) would result in a true positive event. Since there is a single car model in the current geographic area, a positive detection of a position overlap (assuming the GPS sensor and orientation sensor data is accurate) using the minimum dimensions cannot be wrong.

In another example, assume more than one model vehicle exists in the current geographic area (e.g., 2 models). In one example, the distribution of all cars in a current geographic area may be represented by the chart titled “Distribution 1.” In Distribution 1, half (50%) of all of the vehicles in the current geographic area are a “big” vehicle model, while half (50%) of all of the vehicles in the current geographic area are a “small” vehicle model. In such an example, the set of vehicle threshold models may include a maximum vehicle threshold model 373 that assigns dimensions that are larger than that of the “big” vehicle model and a minimum vehicle threshold model 371 that assigns the dimensions equal to that of the “small” vehicle model. Thus, in this embodiment, a confidence value of the maximum vehicle threshold model 373 may be one (1) or 100% (i.e., 1−0=1) and the confidence value of the minimum vehicle threshold model 371 may be 0.5 or 50% (i.e., 1−0.5=0.5).

Thus, in this example, a calculated confidence level of a detected position overlap misbehavior using the maximum vehicle threshold model 373 may be zero (0) or 0% (i.e., 1−1=0) since any position overlap misbehavior condition using dimensions larger than the dimensions of the singular vehicle model would result in a false positive event. As noted above, such false positives may erode at the trust of the V2X system. However, a calculated confidence level of a detected position overlap misbehavior using the minimum vehicle threshold model 371 may be 0.5 (50%) (i.e., 1−0.5=0.5) since any position overlap misbehavior condition using the minimum dimensions (i.e., dimensions of the singular vehicle model) would result in a true positive event for the 50% of the vehicles that are the big model with dimensions bigger than the dimensions assigned in the minimum vehicle threshold model 371.

Thus, in this example, a calculated confidence level of a detected position overlap misbehavior using the maximum vehicle threshold model 373 may be zero (0) or 0% (i.e., 1−1=0) since any position overlap misbehavior condition using dimensions larger than the dimensions of the singular vehicle model would result in a false positive event. As noted above, such false positives may erode at the trust of the V2X system. However, a calculated confidence level of a detected position overlap misbehavior using the minimum vehicle threshold model 371 may be 0.5 (50%) (i.e., 1-0.5=0.5) since any position overlap misbehavior condition using the minimum dimensions (i.e., dimensions of the singular vehicle model) would result in a true positive event for the 50% of the vehicles that are the big model with dimensions bigger than the dimensions assigned in the minimum vehicle threshold model 371.

In some embodiments, a vehicle threshold model 372 may also be contained in the set of vehicle threshold models. The vehicle threshold model 372 may assign dimensions that are smaller than the dimensions of the maximum vehicle threshold model 373, but bigger than the dimensions of minimum vehicle threshold model 371. In a distribution of vehicles in a current geographic area such as represented by Distribution 1, the confidence value assigned to vehicle threshold model 372 may be 0.5. Since 50% (i.e., 0.5) of all vehicles in the current geographic area may be larger than the dimensions assigned in vehicle threshold model 372. Similar to the minimum vehicle threshold model 371, a calculated confidence level of a detected position overlap misbehavior condition using the vehicle threshold model 372 may also be 0.5 (50%) (i.e., 1−0.5=0.5) since any position overlap misbehavior condition using the dimensions assigned in the vehicle threshold model 372 (i.e., dimensions that are smaller than the dimensions of the maximum vehicle threshold model 373, but bigger than the dimensions of minimum vehicle threshold model 371) would result in a true positive event for the 50% of the vehicles that are the big model with dimensions bigger than the dimensions assigned in the vehicle threshold model 372.

With reference to “Distribution 2,” in a current geographic area the percentage of the total vehicles being a “big” vehicle model is 80%, while the percentage of the total vehicles being a “small” vehicle model is 80%. In such an example, the set of vehicle threshold models may include a maximum vehicle threshold model 373 that assigns dimensions that are larger than that of the “big” vehicle model and a minimum vehicle threshold model 371 that assigns the dimensions equal to that of the “small” vehicle model. In addition, a confidence level of the maximum vehicle threshold model 373 may be one (1) or 100% (i.e., 1−0=1) and the confidence level of the minimum vehicle threshold model 371 may be 0.2 or 20% (i.e., 1−0.8=0.2).

Thus, in this example, a calculated confidence level of a detected position overlap misbehavior using the maximum vehicle threshold model 373 may be zero (0%) (e.g., 1−1=0) since any position overlap misbehavior condition using dimensions larger than the dimensions of the singular vehicle model would result in a false positive event. As noted above, such false positives may erode at the trust of the V2X system. However, a calculated confidence level of a detected position overlap misbehavior using the minimum vehicle threshold model 371 may be 0.8 (80%) (e.g., 1−0.2=0.8) since any position overlap misbehavior condition using the minimum dimensions (i.e., dimensions of the singular vehicle model) would result in a true positive event for the 80% of the vehicles that are the big model with dimensions bigger than the dimensions assigned in the minimum vehicle threshold model 371.

As noted above, in some embodiments, a vehicle threshold model 372 may also be contained in the set of vehicle threshold models. The vehicle threshold model 372 may assign dimensions that are smaller than the dimensions of the maximum vehicle threshold model 373, but bigger than the dimensions of minimum vehicle threshold model 371. In a distribution of vehicles in a current geographic area such as represented by Distribution 1, the confidence value assigned to vehicle threshold model 372 may be 0.2. Since 80% (i.e., 0.8) of all vehicles in the current geographic area may be larger than the dimensions assigned in vehicle threshold model 372. Similar to the minimum vehicle threshold model 371, a calculated confidence level of a detected position overlap misbehavior condition using the vehicle threshold model 372 may also be 0.8 (80%) (e.g., 1−0.2=0.8) since any position overlap misbehavior condition using the dimensions assigned in the vehicle threshold model 372 (i.e., dimensions that are smaller than the dimensions of the maximum vehicle threshold model 373, but bigger than the dimensions of minimum vehicle threshold model 371) would result in a true positive event for the 80% of the vehicles that are the big model with dimensions bigger than the dimensions assigned in the vehicle threshold model 372.

While the vehicle threshold model 372 may not be significantly different from the confidence value and calculated confidence level that may be obtained from using the minimum vehicle threshold model 371 in distributions in which there are only two models. However, as the number of models with varying dimensions increases, additional vehicle threshold models (e.g., vehicle threshold model 372) may provide confidence values and calculated confidence levels that vary from the minimum vehicle threshold model 371. Thus, an increase in the granularity and accuracy of the overall V2X system may be provided.

In some embodiments, false negative events may be avoided by assigning minimum dimension values less than the actual “big” and “small” vehicle dimensions. Thus, in such embodiments, the minimum vehicle threshold model 371 may assign a length and width to the vehicle that is less than the actual vehicle dimensions of the “small” vehicle. The maximum vehicle threshold model 373 may assign dimensions that are less than or equal to the “big” vehicle dimensions. In such embodiments, the confidence value assigned to vehicle threshold models may be the total percentage of vehicles in a current geographic area (i.e., one (1) or 100%) minus the percentage of vehicles smaller than the assigned dimensions in the selected vehicle threshold model. Thus, in the example above for Distribution 1, the confidence value for the minimum vehicle threshold model 371 may be one (1) or 100% (i.e., 1−0=1), whereas the confidence value for the maximum vehicle threshold model 373 may be 0.5 or 50% (i.e., 1−0.5=0.5). As in the embodiment discussed above, a calculated confidence level of a position overlap misbehavior detection may be expressed as the percentage of vehicles larger than the minimum dimensions minus the confidence value of the selected vehicle threshold. Thus, in this embodiment, a calculated confidence level of a detected position overlap misbehavior using the minimum vehicle threshold model 371 may be zero (0) or 0% (i.e., 1−1=0) since any position overlap misbehavior condition using dimensions smaller than the dimensions of the singular vehicle model would result in a false negative event. As noted above, such false negatives may erode at the trust of the V2X system. However, a calculated confidence level of a detected position overlap misbehavior using the maximum vehicle threshold model 373 may be 0.5 or 50% (i.e., 1−0.5=0.5) since any position overlap misbehavior condition using the maximum dimensions (i.e., dimensions of the singular vehicle model) would result in a true positive event for the 50% of the vehicles that are the small model with dimensions smaller than the dimensions assigned in the maximum vehicle threshold model 373.

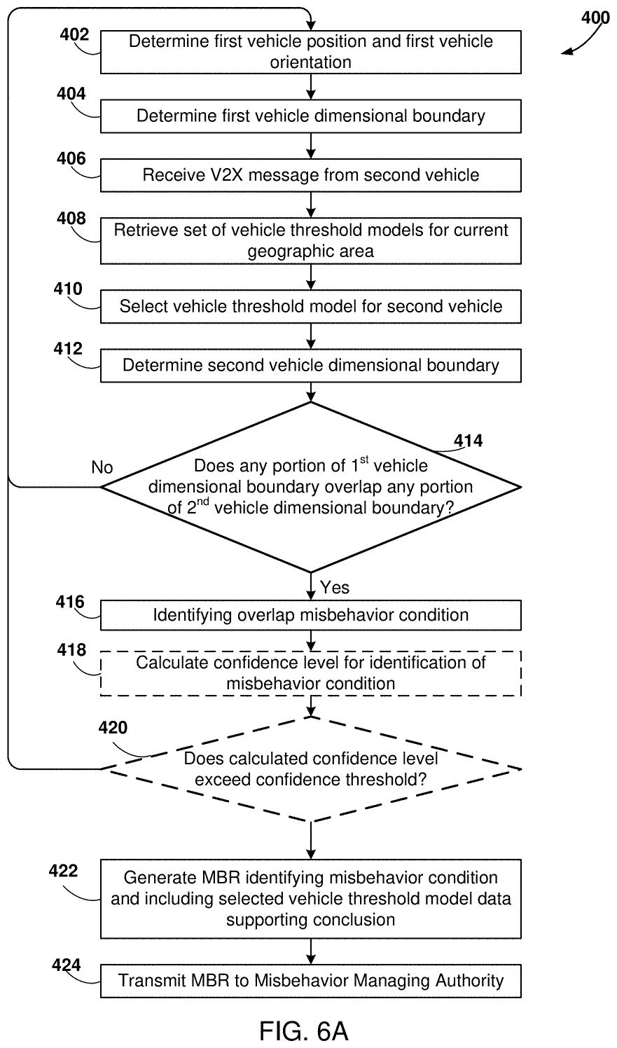

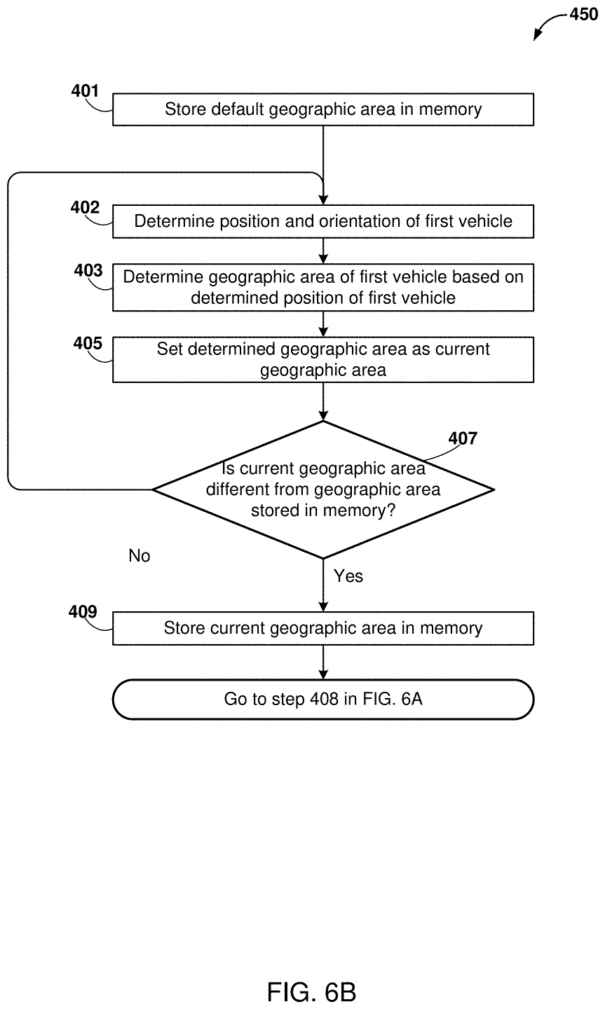

FIG. 6A is a process flow diagram illustrating operations of a method 400 for efficiently performing a position overlap misbehavior detection consistent with various embodiments disclosed herein. With reference to FIGS. 1-6A, the operations of the method 400 may be performed by a processor of a V2X system participant (e.g., any vehicle 12, 14, 16 in FIG. 1D, but for ease of discussion reference may be made to vehicle 16 as the first vehicle (also referred to as the reporting vehicle) and vehicle 12 may be referred to as the second vehicle (also referred to as the neighboring vehicle)). In block 402, the V2X system participant processor in the first vehicle (referred to simply as the first vehicle) may determine the first vehicle position and first vehicle orientation. The first vehicle position and first vehicle orientation may be obtained and determined from a plurality of the first vehicle's sensors that relate to the control maneuvering, navigation, and/or other operations of the V2X system participant (e.g., vehicle 16). The first vehicle's sensors may include any of the various sensors discussed with respect to FIGS. 1A and 1B above.

In block 404, the first vehicle dimensional boundary may be determined based on the first vehicle position, first vehicle orientation, first vehicle length and first vehicle width. In some embodiments, the first vehicle dimensional boundary may be determined using hardcoded or default first vehicle length and first vehicle width values that are trusted values by the first vehicle. In other embodiments, the first vehicle dimensional boundary may be determined by selecting a vehicle threshold model from a set of vehicle threshold models and using the length and width dimensions assigned to the first vehicle therein.

In block 406, the first vehicle may receive a V2X message from a second vehicle. The V2X message that is received by the first vehicle from the second vehicle (e.g., vehicle 12) may include sensor data that provides the second vehicle position and the second vehicle orientation.

In block 408, the first vehicle may retrieve a set of vehicle threshold models. In some embodiments, the set of vehicle threshold models may be retrieved from local memory. In other embodiments, the set of vehicle threshold models may be retrieved from a remote memory. The set of vehicle threshold models may be selected and retrieved based on a current geographic area that the first vehicle is located as described in more detail below with respect to method 450 illustrated in FIG. 6B.

In block 410, the first vehicle may select a vehicle threshold model (e.g., vehicle threshold model 372) that represents the second vehicle. By selecting a particular vehicle threshold model from the set of vehicle threshold models, a selected vehicle threshold model length and a selected vehicle threshold model width may be assigned to the second vehicle. In addition, a confidence value that is contained in the selected vehicle threshold model may also be retrieved.

In block 412, the second vehicle dimensional boundary may be determined based on the second vehicle position and the second vehicle orientation data that is received in the V2X message as well as the length and width dimensions that may be assigned to the second vehicle by the selected vehicle threshold model.

In determination block 414, the first vehicle may determine whether any portion of the first vehicle dimensional boundary overlaps any portion of the second vehicle dimensional boundary. In response to the first vehicle determining that no portion of the first vehicle dimensional boundary overlaps any portion of the second vehicle dimensional boundary (i.e., determination 414=No), the first vehicle may return to monitoring the first vehicle's sensor such as to determine the first vehicle's position and orientation in block 402. In response to the first vehicle determining that a portion of the first vehicle dimensional boundary overlaps any portion of the second vehicle dimensional boundary (i.e., determination 414=Yes), the first vehicle may identify that a position overlap misbehavior condition has occurred in block 416.

In some embodiments, in block 418, the first vehicle may calculate a confidence level of the identification of the position overlap misbehavior condition. As discussed above with reference to FIG. 5, the calculation of the confidence level of the identification of the position overlap misbehavior condition may be based on the selected vehicle threshold model confidence value, such as (percentage of vehicles larger than the minimum dimensions or percentage of vehicles smaller than the maximum dimensions)minus (the selected vehicle threshold model confidence value).

In some embodiments, in determination block 420, the first vehicle may determine whether the calculated confidence level of the identification of the position overlap misbehavior condition exceeds a confidence threshold. In some embodiments, the V2X system may seek to limit the number of MBR that are generated to situations in which the calculated confidence level of an identified misbehavior condition is high. In this manner, the V2X system may limit the generation and transmission of MBRs to situations in which there may be a higher likelihood that a misbehavior condition has occurred. In response to determining that the calculated confidence level does not exceed a confidence threshold (i.e., determination block 420=No), the first vehicle may return to monitoring the first vehicle's sensor such as to determine the first vehicle's position and orientation in block 402. In response to determining that the calculated confidence level does exceed a confidence threshold (i.e., determination block 420=Yes), the first vehicle may generate a MBR that identifies the position overlap misbehavior condition and includes the selected vehicle threshold model data that was used to make the conclusion that the position overlap misbehavior condition has occurred, block 422.

In block 424, the first vehicle may transmit the generated MBR to a misbehavior managing authority 74 for further analysis and confirmation that the position overlap misbehavior condition occurred. In addition, the misbehavior managing authority 74 (sometimes in conjunction with sensor OEM servers 70, 72) determine that the position overlap misbehavior condition may have been identified due to faulty sensor data. In such embodiments, the misbehavior managing authority 74 (sometimes in conjunction with sensor OEM servers 70, 72) may provide the first vehicle with instructions to remediate the sensors (e.g., replacement, repair, new software update, etc.).

In some embodiments, the calculation of the confidence level (block 418) and determination of whether the calculated confidence level exceeds a threshold (determination block 420 may occur after the first vehicle generates a MBR (block 422) but before the operation to transmit the MBR to a misbehavior managing authority 74 (block 424). In this manner, the calculated confidence level may be used to conserve transmission resources (e.g., bandwidth, transmission power). In such embodiment, the MBR that is generated in block 422 may be locally stored until the first vehicle is able to provide the stored MBRs to the misbehavior managing authority 74 such as through a wired download connection.

FIG. 6B is a process flow diagram illustrating operations of a method 450 for efficiently performing a position overlap misbehavior detection consistent with various embodiments disclosed herein. Different geographic areas may have different distributions of vehicle sizes. For example, the size of vehicle models may vary from country to country. Moreover, there may be a larger distribution of trucks and sport utility vehicles in rural geographic areas as compared to urban geographic areas in which traffic and parking concerns may limit the size of vehicles there may be a larger distribution of smaller vehicles. Indeed, the distribution of size vehicles may vary from state to state, county by county, city by city, etc. Thus, in order to accurately determine dimensional boundaries from a set of vehicle threshold models, an appropriate set of vehicle threshold models should be retrieved and/or selected based on the current geographic area in which the first vehicle is currently located. Thus, the first vehicle may periodically check its current location to determine whether the first vehicle has changed its geographic area. If the geographic area has changed, the first vehicle may retrieve a set of vehicle threshold models that accurately reflect the distribution of vehicles for the current geographic areas. As discussed above, the set of vehicle threshold models may contain vehicle dimensions as well as confidence values for each vehicle threshold model. Thus, in some embodiments, the method 450 illustrated in FIG. 6B may be performed before block 408 in FIG. 6A in order to determine for which current geographic area a set of vehicle threshold models may be retrieved.

With reference to FIGS. 1A-6B, in block 401, the V2X system participant processor (i.e., for ease of reference, the first vehicle) may store a default geographic area in memory (local or remote).

As discussed above, in block 402, the first vehicle may determine the position and orientation of the first vehicle. The position and orientation of the first vehicle may be obtained and determined from a plurality of the first vehicle's sensors that relate to the control maneuvering, navigation, and/or other operations of the V2X system participant (e.g., vehicle 16). For example, the first vehicle's GPS sensors may provide a global position location.

In block 403, the first vehicle may compare the determined position to a stored map of geographical areas and the geographical area boundaries to determine a current geographical area (e.g., region, country, state, province, county, city, town, etc.) based on the determined position of the first vehicle.

In block 405, the determined geographic area that the first vehicle is located in may be set as the current geographic area.

In determination block 407, the first vehicle may determine whether the set current geographic area differs from the geographic area that is stored in memory (e.g., default memory). In response to determining that the current geographic area does not differ from the geographic area stored in memory (i.e., determination block 407=No), the first vehicle may loop back to block 402 and continue to determine the position and orientation of the first vehicle. No alterations to the set of vehicle threshold models may be needed. In response to determining that the current geographic area does differ from the geographic area stored in memory (i.e., determination block 407=Yes), the first vehicle may store the set current geographic area in memory to replace the previously stored geographic area (e.g., default geographic area) in block 409 and then proceed to step 408 described with reference to FIG. 6A to retrieve the set of vehicle threshold models appropriate for the current geographic area that the first vehicle is located. In this manner, the first vehicle may assign accurate dimensions to a second vehicle based on the distribution of vehicle models in a current geographic area. In addition, the vehicle threshold models may contain a more accurate confidence value for the assigned dimensions.

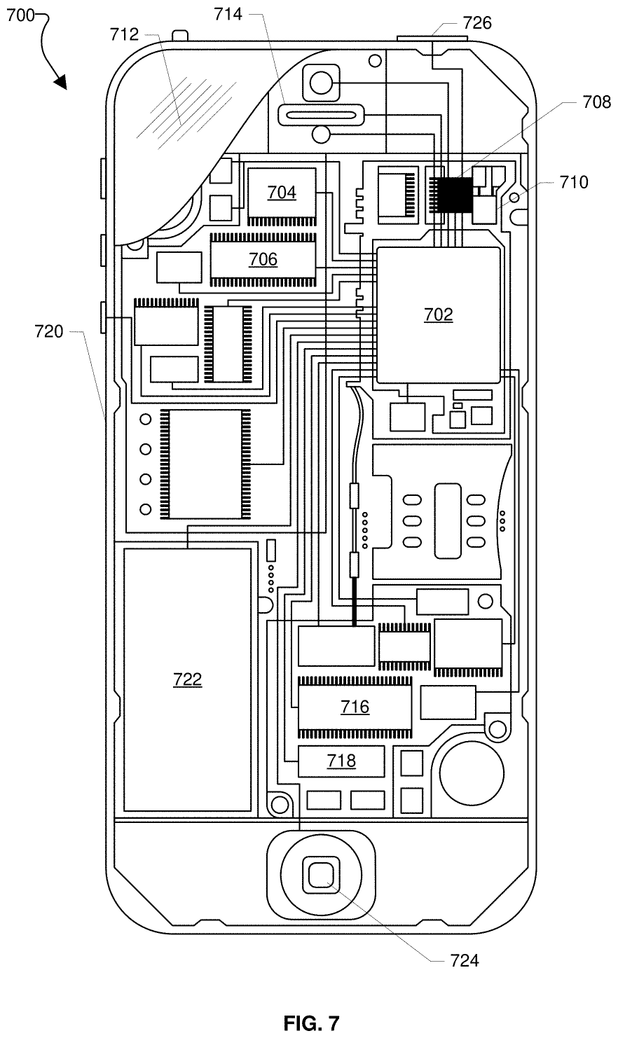

Various embodiments (including, but not limited to, embodiments described above with reference to FIGS. 1A-6B) may be implemented in a wide variety of computing systems including on-board equipment as well as mobile computing devices, an example of which suitable for use with Various embodiments is illustrated in FIG. 7. With reference to FIGS. 1A-7, a mobile computing device 700 may include a processor 702 coupled to a touchscreen controller 704 and an internal memory 706. The processor 702 may be one or more multicore integrated circuits designated for general or specific processing tasks. The internal memory 706 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM. P-RAM, R-RAM. M-RAM, STT-RAM, and embedded DRAM. The touchscreen controller 704 and the processor 702 may also be coupled to a touchscreen panel 712, such as a resistive-sensing touchscreen, capacitive-sensing touchscreen, infrared sensing touchscreen, etc. Additionally, the display of the mobile computing device 700 need not have touch screen capability.

The mobile computing device 700 may have one or more radio signal transceivers 708 (e.g. Peanut, Bluetooth, ZigBee, Wi-Fi, RF radio) and antennae 710, for sending and receiving communications, coupled to each other and/or to the processor 702. The transceivers 708 and antennae 710 may be used with the above-mentioned circuitry to implement the various wireless transmission protocol stacks and interfaces. The mobile computing device 700 may include a cellular network wireless modem chip 716 that enables communication via a cellular network and is coupled to the processor.

The mobile computing device 700 may include a peripheral device connection interface 718 coupled to the processor 702. The peripheral device connection interface 718 may be singularly configured to accept one type of connection, or may be configured to accept various types of physical and communication connections, common or proprietary, such as Universal Serial Bus (USB), FireWire, Thunderbolt, or PCIe. The peripheral device connection interface 718 may also be coupled to a similarly configured peripheral device connection port (not shown).

The mobile computing device 700 may also include speakers 714 for providing audio outputs. The mobile computing device 700 may also include a housing 720, constructed of a plastic, metal, or a combination of materials, for containing all or some of the components described herein. One of ordinary skill in the art may recognize that the housing 720 may be a dashboard console of a vehicle in an on-board embodiment. The mobile computing device 700 may include a power source 722 coupled to the processor 702, such as a disposable or rechargeable battery. The rechargeable battery may also be coupled to the peripheral device connection port to receive a charging current from a source external to the mobile computing device 700. The mobile computing device 700 may also include a physical button 724 for receiving user inputs. The mobile computing device 700 may also include a power button 726 for turning the mobile computing device 700 on and off.

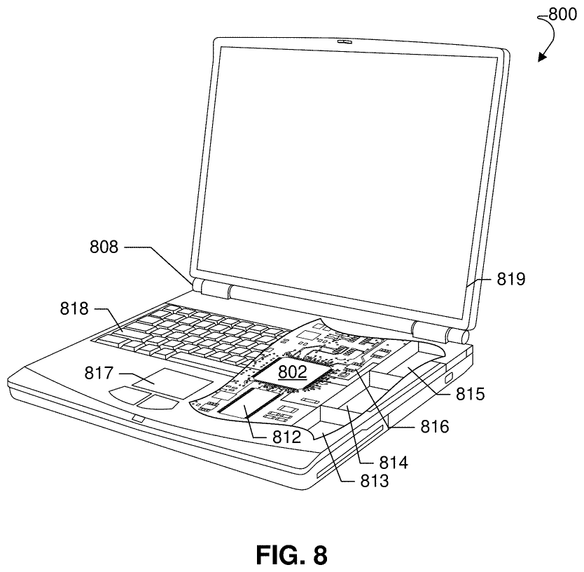

Various embodiments (including, but not limited to, embodiments described above with reference to FIGS. 1A-6B) may be implemented in a wide variety of computing systems include a laptop computer 800 an example of which is illustrated in FIG. 8. Many laptop computers include a touchpad touch surface 817 that serves as the computer's pointing device, and thus may receive drag, scroll, and flick gestures similar to those implemented on computing devices equipped with a touch screen display and described above. A laptop computer 800 will typically include a processor 802 coupled to volatile memory 812 and a large capacity nonvolatile memory, such as a disk drive 813 of Flash memory. Additionally, the computer 800 may have one or more antenna 808 for sending and receiving electromagnetic radiation that may be connected to a wireless data link and/or cellular telephone transceiver 816 coupled to the processor 802. The computer 800 may also include a floppy disc drive 814 and a compact disc (CD) drive 815 coupled to the processor 802. In a notebook configuration, the computer housing includes the touchpad 817, the keyboard 818, and the display 819 all coupled to the processor 802. Other configurations of the computing device may include a computer mouse or trackball coupled to the processor (e.g., via a USB input) as are well known, which may also be used in conjunction with Various embodiments.

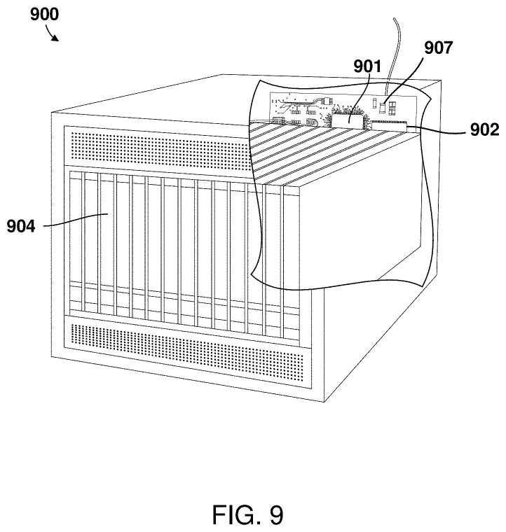

The various embodiments (including, but not limited to, embodiments described above with reference to FIGS. 1A-6B) may by a variety of vehicle computing system, an example of which is illustrated in FIG. 9. A vehicle computing system 900 typically includes one or more multicore processor assemblies 901 coupled to volatile memory 902 and a large capacity nonvolatile memory, such as a disk drive 904. As illustrated in FIG. 9, multicore processor assemblies 901 may be added to the vehicle computing system 900 by inserting them into the racks of the assembly. The vehicle computing system 900 may also include communication ports 907 coupled to the multicore processor assemblies 801 for exchanging data and commands with a radio module (not shown), such as a local area network coupled to other broadcast system computers and servers, the Internet, the public switched telephone network, and/or a cellular data network (e.g. CDMA, TDMA, GSM, PCS, 3G, 4G, 5G, LTE, or any other type of cellular data network).

A number of different cellular and mobile communication services and standards are available or contemplated in the future, all of which may implement and benefit from Various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (OS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Implementation examples are described in the following paragraphs. While some of the following implementation examples are described in terms of example methods, further example implementations may include: the example methods discussed in the following paragraphs implemented by a V2X system processor that may be an onboard unit, mobile device unit, mobile computing unit, or stationary roadside unit including a processor configured with processor-executable instructions to perform operations of the methods of the following implementation examples; the example methods discussed in the following paragraphs implemented by a V2X system including means for performing functions of the methods of the following implementation examples; and the example methods discussed in the following paragraphs may be implemented as a non-transitory processor-readable storage medium having stored thereon processor-executable instructions configured to cause a V2X system processor to perform the operations of the methods of the following implementation examples.

Example 1. A method of performing a position overlap check in a V2X system, including: determining a first vehicle position and a first vehicle orientation of a first vehicle; determining a first vehicle dimensional boundary in which the first vehicle dimensional boundary is based on a first vehicle length, a first vehicle width, the first vehicle position, and the first vehicle orientation; receiving a V2X message from a second vehicle in which the V2X message includes a second vehicle position and a second vehicle orientation; selecting a vehicle threshold model for the second vehicle from a set of threshold vehicle models in which the selected vehicle threshold model includes a selected vehicle threshold model length and a selected vehicle threshold model width, and a selected vehicle threshold model confidence value; determining a second vehicle dimensional boundary in which the second vehicle dimensional boundary is based on the second vehicle position, the second vehicle orientation received in the V2X message, the selected vehicle threshold model length and the selected vehicle threshold model width; determining whether any portion of the first vehicle dimensional boundary overlaps any portion of the second vehicle dimensional boundary; identifying a position overlap misbehavior condition in response to determining that any portion of the first vehicle dimensional boundary overlaps any portion of the second vehicle dimensional boundary; generating a misbehavior report that identifies the position overlap misbehavior condition; and transmitting the misbehavior report to a misbehavior managing authority.

Example 2. The method of example 1, further including selecting the vehicle threshold model from a set of vehicle threshold models for a current geographic area in response to determining that the first vehicle has left a first geographic area and entered the current geographic area, in which the set of vehicle threshold models for the current geographic area is different than the set of vehicle threshold models for the first geographic area.

Example 3. The method of either of examples 1 or 2, further including calculating a confidence level for the identification that a misbehavior condition has occurred in response to identifying the overlap misbehavior condition in which the confidence level for the identification that a misbehavior condition has occurred is based on the selected vehicle threshold model confidence value.

Example 4. The method of example 3, in which a length and a width are assigned to the second vehicle in the vehicle threshold model based on a distribution of vehicle length and vehicle width in a current geographic area.

Example 5. The method of example 4, further including the operation of assigning the first vehicle length and the first vehicle width from values contained in the selected vehicle threshold model.

Example 6. The method of example 4, in which the set of vehicle threshold models include a minimum vehicle threshold model including minimum dimensions and a minimum vehicle confidence value for a minimum vehicle size in the current geographic area, in which the minimum dimensions includes a minimum vehicle length and a minimum vehicle width; and a maximum vehicle threshold model comprising maximum dimensions and a maximum vehicle confidence value for a maximum vehicle size in the current geographic area, in which the maximum dimensions include a maximum vehicle length that is greater than an actual longest vehicle length and a maximum vehicle width that is greater than an actual widest vehicle width.

Example 7. The method example 6, in which the selected vehicle threshold model includes a selected threshold vehicle length, a selected threshold vehicle width and a selected threshold vehicle confidence value of a threshold vehicle in the current geographic area in which the selected threshold vehicle confidence value of the threshold vehicle is a percentage of all vehicles in the current geographic area minus a percentage of vehicles in the current geographic area having an actual length greater than the length of the selected vehicle threshold model and having an actual width greater than the width of the selected vehicle threshold model, further in which the calculated confidence level equals the percentage of vehicles smaller than the minimum dimensions minus the selected vehicle threshold model confidence value of the threshold vehicle in the current geographic area.

Example 8. The method of example 4, in which the set of vehicle threshold models include a minimum vehicle threshold model including minimum dimensions and a minimum vehicle confidence value for a minimum vehicle size in the current geographic area, in which the minimum dimensions includes a minimum vehicle length that is less than an actual shortest vehicle length and a minimum vehicle width that is less than an actual narrowest vehicle width; and a maximum vehicle threshold model including a maximum dimensions and a maximum vehicle confidence value for a maximum vehicle size in the current geographic area, in which the maximum dimensions includes a maximum vehicle length and a maximum vehicle width.

Example 9. The method example 8, in which the selected vehicle threshold model includes a selected threshold vehicle length, a selected threshold vehicle width and a selected threshold vehicle confidence value of a threshold vehicle in the geographic area in which the selected threshold vehicle confidence value of the threshold vehicle is a percentage of all vehicles in the geographic area minus a percentage of vehicles in the geographic area having an actual length less than the length of the selected vehicle threshold model and having an actual width less than the width of the selected vehicle threshold model, further wherein: the calculated confidence level equals the percentage of vehicles larger than the maximum dimensions minus the selected vehicle threshold model confidence value of the threshold vehicle in the geographic area

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter.” “then.” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM. ROM. EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of performing a position overlap check by a first vehicle in a vehicle-to-everything (V2X) system using vehicle threshold model data, comprising:
determining a first vehicle position and a first vehicle orientation of a first vehicle;
determining a first vehicle dimensional boundary, wherein the first vehicle dimensional boundary is based on a first vehicle length, a first vehicle width, the first vehicle position, and the first vehicle orientation;
receiving a V2X message from a second vehicle, wherein the V2X message comprises a second vehicle position and a second vehicle orientation;
selecting a vehicle threshold model for the second vehicle from a set of vehicle threshold models, wherein the selected vehicle threshold model comprises a selected vehicle threshold model length and a selected vehicle threshold model width, and a selected vehicle threshold model confidence value;
determining a second vehicle dimensional boundary, wherein the second vehicle dimensional boundary is based on the second vehicle position, the second vehicle orientation received in the V2X message, the selected vehicle threshold model length and the selected vehicle threshold model width;
determining whether any portion of the first vehicle dimensional boundary overlaps any portion of the second vehicle dimensional boundary;
identifying a position overlap misbehavior condition in response to determining that any portion of the first vehicle dimensional boundary overlaps any portion of the second vehicle dimensional boundary:
generating a misbehavior report that identifies the position overlap misbehavior condition; and
transmitting the misbehavior report to a misbehavior managing authority.

2. The method of claim 1, further comprising:
selecting the vehicle threshold model from a set of vehicle threshold models for a current geographic area in response to determining that the first vehicle has left a first geographic area and entered the current geographic area, wherein the set of vehicle threshold models for the current geographic area is different than the set of vehicle threshold models for the first geographic area.

3. The method of claim 1, further comprising calculating a confidence level for the identification that a misbehavior condition has occurred in response to identifying the overlap misbehavior condition, wherein the confidence level for the identification that a misbehavior condition has occurred is based on the selected vehicle threshold model confidence value.

4. The method of claim 3, wherein a length and a width are assigned to the second vehicle in the vehicle threshold model based on a distribution of vehicle length and vehicle width in in a current geographic area.

5. The method of claim 4, further comprising assigning the first vehicle length and the first vehicle width from values contained in the selected vehicle threshold model.

6. The method of claim 4, wherein the set of vehicle threshold models comprises:
a minimum vehicle threshold model comprising minimum dimensions and a minimum vehicle confidence value for a minimum vehicle size in the current geographic area, wherein the minimum dimensions comprise a minimum vehicle length and a minimum vehicle width; and
a maximum vehicle threshold model comprising maximum dimensions and a maximum vehicle confidence value for a maximum vehicle size in the current geographic area, wherein the maximum dimensions comprise a maximum vehicle length that is greater than an actual longest vehicle length and a maximum vehicle width that is greater than an actual widest vehicle width.

7. The method of claim 6, wherein the selected vehicle threshold model comprises a selected threshold vehicle length, a selected threshold vehicle width and a selected threshold vehicle confidence value of a threshold vehicle in the current geographic area, wherein the selected threshold vehicle confidence value of the threshold vehicle is a percentage of all vehicles in the current geographic area minus a percentage of vehicles in the current geographic area having an actual length greater than the length of the selected vehicle threshold model and having an actual width greater than the width of the selected vehicle threshold model,
further wherein the calculated confidence level equals the percentage of vehicles smaller than the minimum dimensions minus the selected vehicle threshold model confidence value of the threshold vehicle in the current geographic area.

8. The method of claim 4, wherein the set of vehicle threshold models comprises:
a minimum vehicle threshold model comprising minimum dimensions and a minimum vehicle confidence value for a minimum vehicle size in the current geographic area, wherein the minimum dimensions comprise a minimum vehicle length that is less than an actual shortest vehicle length and a minimum vehicle width that is less than an actual narrowest vehicle width; and
a maximum vehicle threshold model comprising maximum dimensions and a maximum vehicle confidence value for a maximum vehicle size in the current geographic area, wherein the maximum dimensions comprise a maximum vehicle length and a maximum vehicle width.

9. The method of claim 8, wherein the selected vehicle threshold model comprises a selected threshold vehicle length, a selected threshold vehicle width and a selected threshold vehicle confidence value of a threshold vehicle in the current geographic area, wherein the selected threshold vehicle confidence value of the threshold vehicle is a percentage of all vehicles in the current geographic area minus a percentage of vehicles in the current geographic area having an actual length less than the length of the selected vehicle threshold model and having an actual width less than the width of the selected vehicle threshold model, further wherein:
the calculated confidence level equals the percentage of vehicles larger than the maximum dimensions minus the selected vehicle threshold model confidence value of the threshold vehicle in the current geographic area.

10. A vehicle-to-everything (V2X) system, comprising:
a memory;
a transceiver; and
a processor coupled to the memory and the transceiver, wherein the processor is configured with processor-executable instructions to:
determine a first vehicle position and a first vehicle orientation of a first vehicle;
determine a first vehicle dimensional boundary, wherein the first vehicle dimensional boundary is based on a first vehicle length, a first vehicle width, the first vehicle position, and the first vehicle orientation;
receive a V2X message from a second vehicle, wherein the V2X message comprises a second vehicle position and a second vehicle orientation;
select a vehicle threshold model for the second vehicle from a set of vehicle threshold models, wherein the selected vehicle threshold model comprises a selected vehicle threshold model length and a selected vehicle threshold model width, and a selected vehicle threshold model confidence value;
determine a second vehicle dimensional boundary, wherein the second vehicle dimensional boundary is based on the second vehicle position, the second vehicle orientation received in the V2X message, the selected vehicle threshold model length and the selected vehicle threshold model width;
determine whether any portion of the first vehicle dimensional boundary overlaps any portion of the second vehicle dimensional boundary;
identify a position overlap misbehavior condition in response to determining that any portion of the first vehicle dimensional boundary overlaps any portion of the second vehicle dimensional boundary;
generate a misbehavior report that identifies the position overlap misbehavior condition; and
transmit the misbehavior report to a misbehavior managing authority.

11. The V2X system of claim 10, wherein the processor is further configured with processor-executable instructions to:
select the vehicle threshold model from a set of vehicle threshold models for a current geographic area in response to determining that the first vehicle has left a first geographic area and entered the current geographic area, wherein the set of vehicle threshold models for the current geographic area is different than the set of vehicle threshold models for the first geographic area.

12. The V2X system of claim 10, wherein the processor is further configured with processor-executable instructions to:
calculate a confidence level for the identification that a misbehavior condition has occurred in response to identifying the overlap misbehavior condition, wherein the confidence level for the identification that a misbehavior condition has occurred is based on the selected vehicle threshold model confidence value.

13. The V2X system of claim 12, wherein a length and a width are assigned to the second vehicle in the vehicle threshold model based on a distribution of vehicle length and vehicle width in a current geographic area.

14. The V2X system of claim 13, wherein the set of vehicle threshold models comprises:
a minimum vehicle threshold model comprising minimum dimensions and a minimum vehicle confidence value for a minimum vehicle size in the current geographic area, wherein the minimum dimensions comprise a minimum vehicle length and a minimum vehicle width; and
a maximum vehicle threshold model comprising maximum dimensions and a maximum vehicle confidence value for a maximum vehicle size in the current geographic area, wherein the maximum dimensions comprise a maximum vehicle length that is greater than an actual longest vehicle length and a maximum vehicle width that is greater than an actual widest vehicle width.

15. The V2X system of claim 14, wherein the selected vehicle threshold model comprises a selected threshold vehicle length, a selected threshold vehicle width and a selected threshold vehicle confidence value of a threshold vehicle in the current geographic area, wherein the selected threshold vehicle confidence value of the threshold vehicle is a percentage of all vehicles in the current geographic area minus a percentage of vehicles in the current geographic area having an actual length greater than the length of the selected vehicle threshold model and having an actual width greater than the width of the selected vehicle threshold model,
further wherein the calculated confidence level equals the percentage of vehicles smaller than the minimum dimensions minus the selected vehicle threshold model confidence value of the threshold vehicle in the current geographic area.

16. The V2X system of claim 13, wherein the set of vehicle threshold models comprises:
a minimum vehicle threshold model comprising minimum dimensions and a minimum vehicle confidence value for a minimum vehicle size in the current geographic area, wherein the minimum dimensions comprise a minimum vehicle length that is less than an actual shortest vehicle length and a minimum vehicle width that is less than an actual narrowest vehicle width; and
a maximum vehicle threshold model comprising a maximum dimensions and a maximum vehicle confidence value for a maximum vehicle size in the current geographic area, wherein the maximum dimensions comprise a maximum vehicle length and a maximum vehicle width.

17. The V2X system of claim 16, wherein the selected vehicle threshold model comprises a selected threshold vehicle length, a selected threshold vehicle width and a selected threshold vehicle confidence value of a threshold vehicle in the current geographic area, wherein the selected threshold vehicle confidence value of the threshold vehicle is a percentage of all vehicles in the current geographic area minus a percentage of vehicles in the current geographic area having an actual length less than the length of the selected vehicle threshold model and having an actual width less than the width of the selected vehicle threshold model, further wherein:
the calculated confidence level equals the percentage of vehicles larger than the maximum dimensions minus the selected vehicle threshold model confidence value of the threshold vehicle in the current geographic area.

18. A vehicle-to-everything (V2X) system, comprising:
means for determining a first vehicle position and a first vehicle orientation of a first vehicle;
means for determining a first vehicle dimensional boundary, wherein the first vehicle dimensional boundary is based on a first vehicle length, a first vehicle width, the first vehicle position, and the first vehicle orientation;
means for receiving a V2X message from a second vehicle, wherein the V2X message comprises a second vehicle position and a second vehicle orientation;
means for selecting a vehicle threshold model for the second vehicle from a set of vehicle threshold models, wherein the selected vehicle threshold model comprises a selected vehicle threshold model length and a selected vehicle threshold model width, and a selected vehicle threshold model confidence value;
means for determining a second vehicle dimensional boundary, wherein the second vehicle dimensional boundary is based on the second vehicle position, the second vehicle orientation received in the V2X message, the selected vehicle threshold model length and the selected vehicle threshold model width;
means for determining whether any portion of the first vehicle dimensional boundary overlaps any portion of the second vehicle dimensional boundary;
means for identifying a position overlap misbehavior condition in response to determining that any portion of the first vehicle dimensional boundary overlaps any portion of the second vehicle dimensional boundary;
means for generating a misbehavior report that identifies the position overlap misbehavior condition; and
means for transmitting the misbehavior report to a misbehavior managing authority.

19. The V2X system of claim 18, further comprising:
means for determining that the first vehicle has left a first geographic area and entered a current geographic area; and
means for selecting the vehicle threshold model from a set of vehicle threshold models for the current geographic area, wherein the set of vehicle threshold models for the current geographic area is different than the set of vehicle threshold models for the first geographic area.

20. The V2X system of claim 18, further comprising:
means for calculating a confidence level for the identification that a misbehavior condition has occurred in response to identifying the overlap misbehavior condition, wherein the confidence level for the identification that a misbehavior condition has occurred is based on the selected vehicle threshold model confidence value.

21. The V2X system of claim 20, wherein a length and a width are assigned to the second vehicle in the vehicle threshold model based on a distribution of vehicle length and vehicle width in in a current geographic area.

22. The V2X system of claim 21, wherein the set of vehicle threshold models comprises:
a minimum vehicle threshold model comprising minimum dimensions and a minimum vehicle confidence value for a minimum vehicle size in the current geographic area, wherein the minimum dimensions comprise a minimum vehicle length and a minimum vehicle width; and
a maximum vehicle threshold model comprising maximum dimensions and a maximum vehicle confidence value for a maximum vehicle size in the current geographic area, wherein the maximum dimensions comprise a maximum vehicle length that is greater than an actual longest vehicle length and a maximum vehicle width that is greater than an actual widest vehicle width.

23. The V2X system of claim 22, wherein the selected vehicle threshold model comprises a selected threshold vehicle length, a selected threshold vehicle width and a selected threshold vehicle confidence value of a threshold vehicle in the current geographic area, wherein the selected threshold vehicle confidence value of the threshold vehicle is a percentage of all vehicles in the current geographic area minus a percentage of vehicles in the current geographic area having an actual length greater than the length of the selected vehicle threshold model and having an actual width greater than the width of the selected vehicle threshold model,
further wherein the calculated confidence level equals the percentage of vehicles smaller than the minimum dimensions minus the selected vehicle threshold model confidence value of the threshold vehicle in the current geographic area.

24. The V2X system of claim 21, wherein the set of vehicle threshold models comprises:
a minimum vehicle threshold model comprising minimum dimensions and a minimum vehicle confidence value for a minimum vehicle size in the current geographic area, wherein the minimum dimensions comprise a minimum vehicle length that is less than an actual shortest vehicle length and a minimum vehicle width that is less than an actual narrowest vehicle width; and
a maximum vehicle threshold model comprising a maximum dimensions and a maximum vehicle confidence value for a maximum vehicle size in the current geographic area, wherein the maximum dimensions comprise a maximum vehicle length and a maximum vehicle width.

25. The V2X system of claim 24, wherein the selected vehicle threshold model comprises a selected threshold vehicle length, a selected threshold vehicle width and a selected threshold vehicle confidence value of a threshold vehicle in the current geographic area, wherein the selected threshold vehicle confidence value of the threshold vehicle is a percentage of all vehicles in the current geographic area minus a percentage of vehicles in the current geographic area having an actual length less than the length of the selected vehicle threshold model and having an actual width less than the width of the selected vehicle threshold model,
further wherein the calculated confidence level equals the percentage of vehicles larger than the maximum dimensions minus the selected vehicle threshold model confidence value of the threshold vehicle in the current geographic area.

26. A non-transitory processor-readable medium having stored thereon processor-executable instructions configured to cause a processor of a vehicle-to-everything (V2X) system to perform operations comprising:
determining a first vehicle position and a first vehicle orientation;
determining a first vehicle dimensional boundary, wherein the first vehicle dimensional boundary is based on a first vehicle length, a first vehicle width, the first vehicle position, and the first vehicle orientation;
receiving a V2X message from a second vehicle, wherein the V2X message comprises a second vehicle position and a second vehicle orientation;
selecting a vehicle threshold model for the second vehicle from a set of vehicle threshold models, wherein the selected vehicle threshold model comprises a selected vehicle threshold model length and a selected vehicle threshold model width, and a selected vehicle threshold model confidence value;
determining a second vehicle dimensional boundary, wherein the second vehicle dimensional boundary is based on the second vehicle position, the second vehicle orientation received in the V2X message, the selected vehicle threshold model length and the selected vehicle threshold model width;
determining whether any portion of the first vehicle dimensional boundary overlaps any portion of the second vehicle dimensional boundary;
identifying a position overlap misbehavior condition in response to determining that any portion of the first vehicle dimensional boundary overlaps any portion of the second vehicle dimensional boundary;
generating a misbehavior report that identifies the position overlap misbehavior condition; and
transmitting the misbehavior report to a misbehavior managing authority.

27. The non-transitory processor-readable medium of claim 26, wherein the stored processor-executable instructions are further configured to cause the processor of the V2X system to perform the operations comprising calculating a confidence level for the identification that a misbehavior condition has occurred in response to identifying the overlap misbehavior condition, wherein the confidence level for the identification that a misbehavior condition has occurred is based on the selected vehicle threshold model confidence value.

28. The non-transitory processor-readable medium of claim 27, wherein the stored processor-executable instructions are further configured to cause the processor of the V2X system to perform operations such that a length and a width are assigned to the second vehicle in the vehicle threshold model based on a distribution of vehicle length and vehicle width in in a current geographic area.

29. The non-transitory processor-readable medium of claim 28, wherein the stored processor-executable instructions are further configured to cause the processor of the V2X system to perform operations such that the set of vehicle threshold models comprises:
a minimum vehicle threshold model comprising minimum dimensions and a minimum vehicle confidence value for a minimum vehicle size in the current geographic area, wherein the minimum dimensions comprise a minimum vehicle length and a minimum vehicle width; and
a maximum vehicle threshold model comprising maximum dimensions and a maximum vehicle confidence value for a maximum vehicle size in the current geographic area, wherein the maximum dimensions comprise a maximum vehicle length that is greater than an actual longest vehicle length and a maximum vehicle width that is greater than an actual widest vehicle width.

30. The non-transitory processor-readable medium of claim 29, wherein the stored processor-executable instructions are further configured to cause the processor of the V2X system to perform operations such that the selected vehicle threshold model comprises a selected threshold vehicle length, a selected threshold vehicle width and a selected threshold vehicle confidence value of a threshold vehicle in the current geographic area, wherein the selected threshold vehicle confidence value of the threshold vehicle is a percentage of all vehicles in the current geographic area minus a percentage of vehicles in the current geographic area having an actual length greater than the length of the selected vehicle threshold model and having an actual width greater than the width of the selected vehicle threshold model; and
the calculated confidence level equals the percentage of vehicles smaller than the minimum dimensions minus the selected vehicle threshold model confidence value of the threshold vehicle in the current geographic area.
